(19) United States
(12) Patent Application Publication
(10) Pub. No.: US 2026/0102307 A1
(43) Pub. Date: Apr. 16, 2026

(54) WEARABLE DEVICE FOR PROVIDING VOICE TO USER AND METHOD OF OPERATING THE SAME

(71) Applicant: Samsung Electronics Co., Ltd., Suwon-si (KR)

(72) Inventors: Sumin CHOI, Suwon-si (KR); Hoon HAN, Suwon-si Gyeonggi-do (KR)

(21) Appl. No.: 19/349,614

(22) Filed: Oct. 3, 2025

Related U.S. Application Data
(63) Continuation of application No. PCT/KR2025/012360, filed on Aug. 14, 2025.

(30) Foreign Application Priority Data
Oct. 11, 2024 (KR) 10-2024-0138979

(51) Int. Cl. A61H 3/00; A61H 1/02; G10L 13/02

(52) U.S. Cl. CPC A61H 3/00; G10L 13/02; A61H 1/0244; A61H 2201/5007; A61H 2201/5048; A61H 2201/5079; A61H 2201/5097; A61H 2230/06; A61H 2230/42; A61H 2230/62

(57) ABSTRACT

A wearable device provides a torque to a user performing an exercise, obtains an index of burden on a body of the user based on at least one of exercise information about exercise execution of the user, biometric information of the user, or settings information that is set to the wearable device to provide the torque, selects a sentence used for voice generation of the wearable device based on the index, and generates a voice based on the selected sentence and provides the generated voice to the user.

### CROSS-REFERENCE TO RELATED APPLICATIONS

This application is a continuation application of International Application No. PCT/KR2025/012360 designating the United States, filed on Aug. 14, 2025, in the Korean Intellectual Property Receiving Office and claiming priority to Korean Patent Application No. 10-2024-0138979, filed on Oct. 11, 2024, in the Korean Intellectual Property Office, the disclosures of which are incorporated by reference herein in their entireties.

### BACKGROUND

### 1. Field

An example embodiment relates to a wearable device for providing a voice to a user and/or an operating method thereof.

### 2. Description of Related Art

An assistance device may refer to a tool or device for assisting a user in performing an exercise and/or motion. The assistance device may be worn on the body of the user and may provide a force required to perform the exercise or motion to the user.

### SUMMARY

According to an example embodiment, a wearable device for providing an optimized voice to a user may be provided.

According to an example embodiment, a wearable device may include a driving module comprising a motor and/or circuitry, at least one processor comprising processing circuitry, and memory storing instructions. The instructions that, when executed by the at least one processor individually or collectively, may cause the wearable device to control the driving module to provide a torque to a user performing an exercise. The instructions that, when executed by the at least one processor individually or collectively, may cause the wearable device to obtain an index of burden on a body of the user based on at least one of exercise information about exercise execution of the user, biometric information of the user, or settings information that is set to the wearable device to provide the torque. The instructions that, when executed by the at least one processor individually or collectively, may cause the wearable device to select a sentence used for voice generation of the wearable device based on the index. The instructions that, when executed by the at least one processor individually or collectively, may cause the wearable device to generate a voice based on the selected sentence and provides the generated voice to the user.

According to an embodiment, a wearable device a driving module, comprising a motor and/or circuitry, at least one processor comprising processing circuitry, and memory storing instructions. The instructions that, when executed by the at least one processor individually or collectively, may cause the wearable device to when an exercise program is selected, obtain a plurality of sentence groups for the exercise program. The instructions that, when executed by the at least one processor individually or collectively, may cause the wearable device to determine sentence groups to be used for a voice service of the wearable device from the obtained sentence groups based on at least one of profile information of a user, information about whether an electronic device that establishes a wireless communication link with the wearable device exists, or surrounding environmental information of the user. The instructions that, when executed by the at least one processor individually or collectively, may cause the wearable device to control the driving module to provide a torque to the user performing an exercise of the exercise program.

According to an embodiment, a method of operating a wearable device may include providing a torque to a user who performs an exercise, obtaining an index of a degree of burden on a body of the user based on at least one of exercise information about exercise execution of the user, biometric information of the user, or settings information that is set to the wearable device to provide the torque, selecting a sentence used for voice generation of the wearable device based on the index, and generating a voice based on the selected sentence and providing the generated voice to the user.

According to an embodiment, a wearable device may optimize an amount of speech of the wearable device by considering at least one of an age of a user, a surrounding environment in which an exercise of the user is performed, or whether there is an electronic device connected to the wearable device.

According to an embodiment, the wearable device may optimize (or adjust) an amount of speech of the wearable device according to a language processing ability (or a degree of burden on a body of the user) of the user during the exercise.

### BRIEF DESCRIPTION OF THE DRAWINGS

The above and other aspects, features, and advantages of certain example embodiments of the present disclosure will be more apparent from the following detailed description, taken in conjunction with the accompanying drawings, in which:

FIG. 1A is a diagram illustrating an overview of a wearable device worn on a body of a user according to an example embodiment;

FIG. 1B is a diagram illustrating an example of a system including a wearable device according to an example embodiment;

FIG. 2A is a rear schematic view of a wearable device according to an example embodiment;

FIG. 2B is a left side view of a wearable device according to an example embodiment;

FIGS. 3A and 3B are block diagrams illustrating examples of a configuration of a wearable device according to an example embodiment;

FIG. 4 is a diagram illustrating an interaction between a wearable device and an electronic device according to an example embodiment;

FIG. 5 is a diagram illustrating an example of communication between a wearable device and one or more electronic devices according to an example embodiment;

FIG. 6 is a diagram illustrating a sentence set and sentence groups included in the sentence set according to an example embodiment;

FIGS. 7 and 8 are diagrams illustrating examples of a method of adjusting the amount of speech by a wearable device according to an example embodiment;

FIGS. 9 and 10 are diagrams illustrating an example of adjusting the amount of speech by a wearable device based on an index calculated during an exercise of a user according to an example embodiment;

FIGS. 11, 12, and 13 are diagrams illustrating examples of speech styles of a wearable device according to an example embodiment(s);

FIG. 14 is a diagram illustrating an example of a method of generating a sentence by a wearable device by using a language model according to an example embodiment;

FIGS. 15 and 16 are diagrams illustrating examples of a speech operation of a wearable device according to an example embodiment(s); and

FIG. 17 is a flowchart illustrating an example of an operating method of a wearable device according to an example embodiment.

### DETAILED DESCRIPTION

The following detailed structural or functional description is provided as an example only and various alterations and modifications may be made to the embodiments.

Accordingly, the embodiments are not construed as limited to the disclosure and should be understood to include all changes, equivalents, and replacements within the idea and the technical scope of the disclosure.

Although terms, such as first, second, and the like are used to describe various components, the components are not limited to the terms. These terms should be used only to distinguish one component from another component. For example, a first component may be referred to as a second component, and similarly, the second component may also be referred to as the first component.

It should be noted that if it is described that one component is “connected”, “coupled”, or “joined” to another component, at least a third component may be “connected”, “coupled”, and “joined” between the first and second components, although the first component may be directly connected, coupled, or joined to the second component. Thus, for example, “connected” and “coupled” as used herein cover direct and indirect connections.

As used herein, the singular forms “a,” “an,” and “the” are intended to include the plural forms as well, unless the context clearly indicates otherwise. It will be further understood that the terms “comprises/comprising” and/or “includes/including” when used herein, specify the presence of stated features, integers, steps, operations, elements, and/or components, but do not preclude the presence or addition of one or more other features, integers, steps, operations, elements, components and/or groups thereof.

Unless otherwise defined, all terms, including technical and scientific terms, used herein have the same meaning as commonly understood by one of ordinary skill in the art to which the present disclosure pertains. It will be further understood that terms, such as those defined in commonly-used dictionaries, should be interpreted as having a meaning that is consistent with their meaning in the context of the relevant art and will not be interpreted in an idealized or overly formal sense unless expressly so defined herein.

Hereinafter, embodiments will be described in detail with reference to the accompanying drawings. When describing the embodiments with reference to the accompanying drawings, like reference numerals refer to like elements and a repeated description related thereto will be omitted.

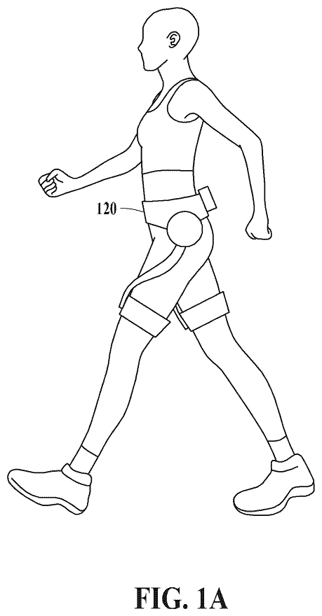

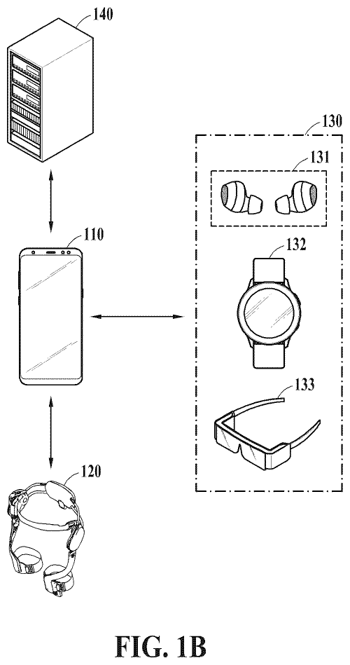

FIG. 1A is a diagram illustrating an overview of a wearable device worn on a body of a user according to an example embodiment.

Referring to FIG. 1A, a wearable device 120 may be a device worn on a body of a user to assist the user in walking, exercising, and/or working. In an embodiment, the term “wearable device” may be replaced with “wearable robot”, “walking assistance device”, or “exercise assistance device”. The user may be a human or an animal, but is not limited thereto. The wearable device 120 may be worn on a body (e.g., a lower body (the legs, ankles, knees, etc., an upper body (the torso, arms, wrists, etc.), or the waist) of the user to provide an external force such as an external force (e.g., an assistance force and/or a resistance) force to a body motion of the user. The assistance force (or assistance torque) may be a force applied in the same direction as the body motion direction of the user, and the resistance force (or resistance torque) may be a force applied in a direction opposite to the body motion direction of the user.

When the wearable device 120 performs a walking assist function to assist the user in walking, the wearable device 120 may assist a portion or entirety of a leg of the user by providing an assistance force (or assistance torque) to the body of the user, thereby assisting the user in walking. The wearable device 120 may enable the user to walk independently or to walk for a long time by providing a force required for the user to walk, thereby extending the walking ability of the user. The wearable device 120 may help in improving an abnormal walking habit or walking posture of a walker.

When the wearable device 120 performs an exercise function to enhance the exercise effect of the user, the wearable device 120 may hinder a body motion of the user or provide resistance to a body motion of the user by providing a resistance force (or resistance torque) to the body of the user. When the wearable device 120 is, for example, a hip-type wearable device, the wearable device 120 may provide the resistance force to a body motion of the user while being worn on the legs, thereby enhancing the exercise effect of the user. The user may perform a walking motion while wearing the wearable device 120 for exercise. In this case, the wearable device 120 may apply a resistance force to the leg motion during the walking motion of the user.

In an embodiment, an example of a hip-type wearable device 120 that is worn on the waist and legs is described for ease of description. However, as described above, the wearable device 120 may be worn on another body part (e.g., the upper arms, lower arms, hands, calves, and feet) other than the waist and legs (particularly, the thighs), and the shape and configuration of the wearable device 120 may vary depending on the body part on which the wearable device 120 is worn.

FIG. 1B is a diagram illustrating an example of a system including a wearable device according to an example embodiment.

Referring to FIG. 1B, an electronic device 110 may communicate with the wearable device 120 and remotely control the wearable device 120. The electronic device 110 may be various types of devices. The electronic device 110 may include, for example, a portable communication device (e.g., a smart phone), a computer device, a portable multimedia device, or a home appliance, but is not limited thereto.

According to an embodiment, the electronic device 110 and/or the wearable device 120 may be connected to another wearable device 130. For example, the wearable device 120, the electronic device 110, and the other wearable device 130 may be connected to each other through a wireless communication link (e.g., a Bluetooth communication link). The other wearable device 130 may include, for example, wireless earphones 131, a smartwatch 132, or smart glasses 133, but is not limited thereto. The smartwatch 132 may be a watch-type wearable device (or a watch-type electronic device), and the smart glasses 133 may be an eyewear-type wearable device (or an eyewear-type electronic device).

In an embodiment, the wearable device 120 may establish a direct wireless communication link (e.g., a Bluetooth link) with the other wearable device 130.

In an embodiment, the smartwatch 132 may control the wearable device 120. When the smartwatch 132 is connected to the electronic device 110 via a wireless communication link, and the electronic device 110 is connected to the wearable device 120 via a wireless communication link, the smartwatch 132 may control the wearable device 120 through the electronic device 110. Embodiments are not limited thereto, and the smartwatch 132 may be directly connected to the wearable device 120 and control the wearable device 120.

In an embodiment, the wearable device 120 may receive information about a heart rate of a user from the smartwatch 132.

In an embodiment, the electronic device 110 may transmit, to the other wearable device 130, a control signal to instruct to provide a user with feedback corresponding to a state of the wearable device 120. The other wearable device 130 may provide (or output) feedback (e.g., at least one of visual feedback, auditory feedback, or haptic feedback) corresponding to the state of the wearable device 120 in response to the reception of the control signal.

In an embodiment, the electronic device 110 may communicate with a server 140 using short-range wireless communication (e.g., Wi-Fi) or mobile communication (e.g., 4G, 5G, etc.).

In an embodiment, the electronic device 110 may receive user information (e.g., profile information) from the user. The profile information may include, for example, at least one of the age, gender, height, weight, or body mass index (BMI), or a combination thereof. The electronic device 110 may transmit the profile information of the user to the server 140 and/or the wearable device 120.

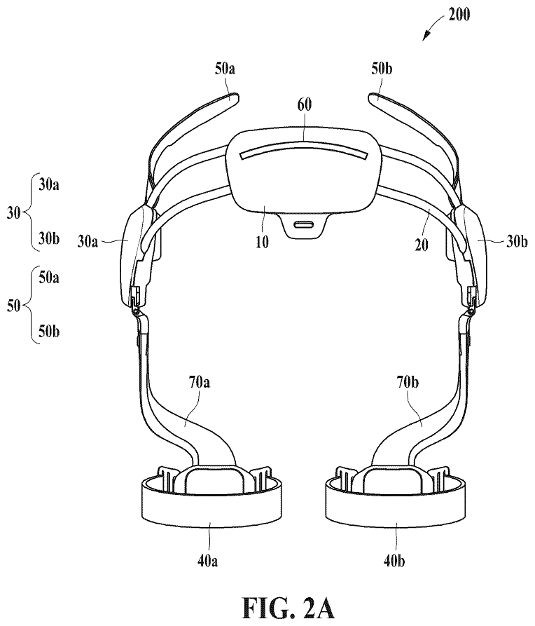

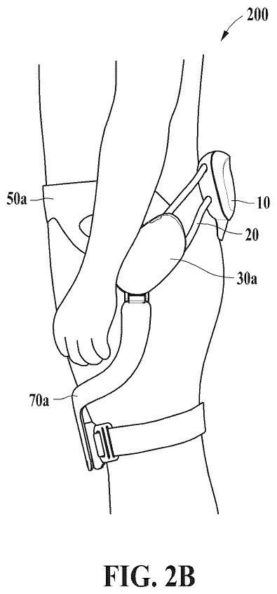

FIG. 2A is a rear schematic view of a wearable device according to an example embodiment. FIG. 2B is a left side view of a wearable device according to an example embodiment.

A wearable device 200 shown in FIGS. 2A and 2B may be an example of the wearable device 120.

Referring to FIG. 2A, the wearable device 200 according to an embodiment may include a lumbar support module 10, a lumbar frame 20, a driving module 30, thigh fastening portions 40a and 40b, a main belt 50, and thigh frames 70a and 70b.

According to an embodiment, the lumbar support module 10 may be positioned on the lumbar region (lower back area) of the user while the user is wearing the wearable device 200. The lumbar support module 10 may be mounted on the lumbar region of the user to provide a cushioning feeling to the waist of the user and support the waist of the user. The lumbar support module 10 may be hung on the hip region (an area of the hips) to prevent or reduce chances of the wearable device 200 from being downwardly separated due to gravity while the user is wearing the wearable device 200. The lumbar support module 10 may distribute some of the weight of the wearable device 200 to the waist of the user while the user is wearing the wearable device 200. The lumbar support module 10 may be connected to the lumbar frame 20. Connecting elements (not shown) that may be connected to the lumbar frame 20 may be formed at both end portions of the lumbar support module 10.

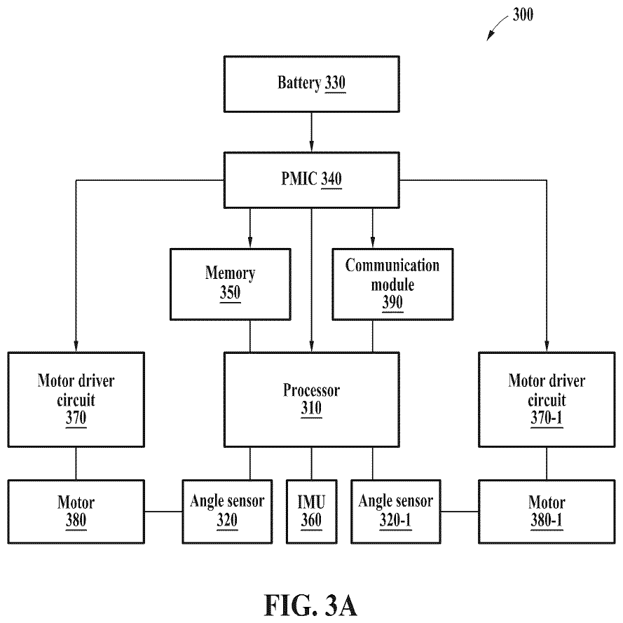

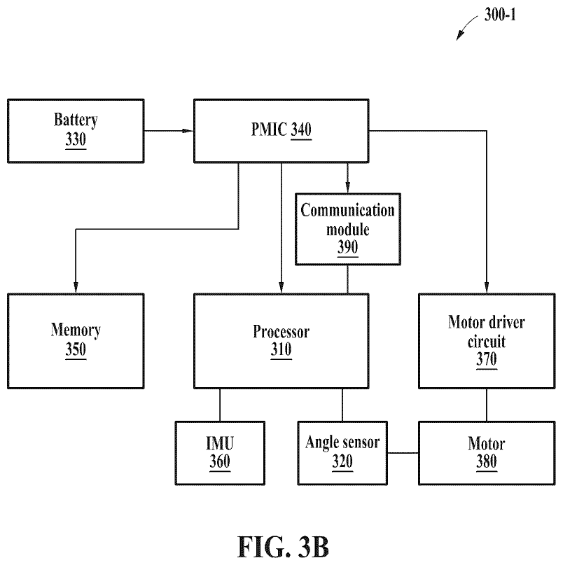

According to an embodiment, the lumbar support module 10 may include a lighting unit 60. The lighting unit 60 may include a plurality of light sources (e.g., light-emitting diodes (LEDs)). The lighting unit 60 may emit light by control of a processor (e.g., a processor 310 of FIGS. 3A and 3B described below). Depending on the embodiments, the processor may control the lighting unit 60 such that visual feedback corresponding to the state of the wearable device 200 (e.g., a booting state, a sensing state, etc.) may be provided (or output) to the user through the lighting unit 60.

According to an embodiment, the lumbar frame 20 may extend from both end portions of the lumbar support module 10. The lumbar region of the user may be accommodated inside the lumbar frame 20. The lumbar support frame 20 may include at least one rigid body beam. Each beam may be in a curved shape having a preset curvature to enclose the lumbar region of the user. The main belt 50 may be connected to an end portion of the lumbar frame 20. The driving module 30 may be mounted on, directly or indirectly, the lumbar frame 20. The lumbar frame 20 may include a connector (not shown) for mounting the driving module 30 thereon.

According to an embodiment, the driving module 30 may include a first driving module 30a positioned on the left side of the user while the user is wearing the wearable device 200, and a second driving module 30b positioned on the right side of the user while the user is wearing the wearable device 200.

According to an embodiment, the first driving module 30a may include a first angle sensor (e.g., a first encoder or a first Hall sensor) for measuring the angle (e.g., a left hip joint angle) of a first joint of the user. The second driving module 30b may include a second angle sensor (e.g., a second encoder or a second Hall sensor) for measuring the angle (e.g., a right hip joint angle) of a second joint of the user.

According to an embodiment, the first driving module 30a and the second driving module 30b may generate a torque (e.g., a resistance torque or an assistance torque). The first driving module 30a may be connected to the first thigh frame 70a and the second driving module 30b may be connected to the second thigh frame 70b. The first driving module 30a may provide the generated torque to the left leg of the user through the first thigh frame 70a. The first thigh frame 70a may provide an external force to the left leg of the user by rotating through the torque generated by the first driving module 30a. The second driving module 30b may provide the generated torque to the right leg of the user through the second thigh frame 70b. The second thigh frame 70b may provide an external force to the right leg of the user by rotating through the torque generated by the second driving module 30b.

According to an embodiment, the thigh frames 70a and 70b may support the legs (e.g., thighs) of the user when the wearable device 200 is worn on the legs of the user. The thigh frames 70a and 70b may include the first thigh frame 70a for supporting the left leg of the user and the second thigh frame 70b for supporting the right leg of the user.

According to an embodiment, the thigh frames 70a and 70b may transmit a torque generated by, for example, the driving modules 30a and 30b to the thighs of the user. As one end portions of the thigh frames 70a and 70b are connected to the driving modules 30a and 30b to rotate, and the other end portions of the thigh frames 70a and 70b are connected to the thigh fastening portions 40a and 40b, the thigh frames 70a and 70b may transmit the torques generated by the driving modules 30a and 30b to the thighs of the user while supporting the thighs of the user. For example, the thigh frames 70a and 70b may push or pull the thighs of the user. The thigh frames 70a and 70b may extend in the longitudinal direction of the thighs of the user. The thigh frames 70a and 70b may be bent to surround at least a portion of the circumferences of the thighs of the user.

According to an embodiment, the thigh fastening portions 40a and 40b may be connected to the thigh frames 70a and 70b and may fasten the thigh frames 70a and 70b to the thighs. The thigh fastening portions 40a and 40b may include the first thigh fastening portion 40a for fastening the first thigh frame 70a to the left thigh of the user and a second thigh fastening portion 40b for fastening the second thigh frame 70b to the right thigh of the user.

According to an embodiment, the first thigh fastening portion 40a may include a first cover, a first fastening frame, and a first strap, and the second thigh fastening portion 40b may include a second cover, a second fastening frame, and a second strap. The first cover and the second cover may be arranged on one sides of the thighs of the user. The first cover and the second cover may be arranged on the front surfaces of the thighs of the user. The first cover and the second cover may be arranged in the circumferential directions of the thighs of the user. The first cover and the second cover may extend to both sides from the other end portions of the thigh frames 70a and 70b and may include curved surfaces corresponding to the thighs of the user. One ends of the first cover and the second cover may be connected to the fastening frames, and the other ends thereof may be connected to the straps.

According to an embodiment, the first fastening frame and the second fastening frame may be arranged, for example, to surround at least some portions of the circumferences of the thighs of the user, thereby preventing or reducing chances of the thighs of the user from being separated from the thigh frames 70a and 70b. The first fastening frame may have a fastening structure that connects the first cover to the first strap, and the second fastening frame may have a fastening structure that connects the second cover to the second strap.

According to an embodiment, the first strap may enclose the remaining portion of the circumference of the left thigh of the user that is not covered by the first cover and the first fastening frame, and the second strap may enclose the remaining portion of the circumference of the right thigh of the user that is not covered by the second cover and the second fastening frame. The first strap and the second strap may include, for example, an elastic material (e.g., a band).

According to an embodiment, the main belt 50 may be connected to the lumbar frame 20. The main belt 50 may include a first main belt 50a configured to enclose the left abdomen of the user while the user is wearing the wearable device 200, and a second main belt 50b configured to enclose the right abdomen of the user while the user is wearing the wearable device 200. The first main belt 50a may be formed in a shape having a longer length than the second main belt 50b, but is not limited thereto, and the first main belt 50a may be formed in a shape having the same length as or a shorter length than the second main belt 50b. The first main belt 50a and the second main belt 50b may be connected to both end portions of the lumbar frame 20, respectively. The main belt 50 may be bent in a direction to surround the abdomen of the user when the body of the user is inserted in such a direction that it is accommodated in the wearable device 200. The first main belt 50a and the second main belt 50b may be connected to each other while the user is wearing the wearable device 200. The main belt 50 may distribute a portion of the weight of the wearable device 200 to the abdomen of the user while the user is wearing the wearable device 200.

Referring to FIG. 2B, the lumbar support module 10 may be mounted on, directly or indirectly, the back of the lumbar region of the user and be hung on the hip region of the user, thereby supporting some of the weight of the wearable device 200. The first driving module 30a may be arranged on the left lumbar region of the user. The lumbar frame 20 may extend from the end portion of the lumbar support frame 10 and may be inclined in a direction toward the first driving module 30a. The first main belt 50a mounted on, directly or indirectly, the lumbar frame 20 may surround the left abdomen of the user.

FIGS. 3A and 3B are block diagrams illustrating examples of a configuration of a wearable device according to an example embodiment.

Referring to FIG. 3A, a wearable device 300 in an embodiment may include a processor 310, angle sensors 320 and 320-1, a battery 330, a power management integrated circuit (PMIC) 340, a memory 350, an IMU 360, motor driver circuits 370 and 370-1, motors (or actuators) 380 and 380-1, and a communication module 390.

Although the plurality of angle sensors 320 and 320-1, the plurality of motor driver circuits 370 and 370-1, and the plurality of motors 380 and 380-1 are shown in FIG. 3, which is merely an example, the wearable device 300-1 in the example shown in FIG. 3B may include a single angle sensor 320, a single motor driver circuit 370, and a single motor 380. Also, according to the implementation, the wearable devices 300 and 300-1 may include a plurality of processors. The number of motor driver circuits, the number of motors, or the number of processors may vary depending on a body part on which the wearable devices 300 and 300-1 are worn.

The wearable device 300 in FIG. 3A and the wearable device 300-1 of FIG. 3B may be examples of the wearable device 120 and the wearable device 200.

According to an embodiment, the angle sensor 320, the motor driver circuit 370, and the motor 380 may be included in the first driving module 30a of FIG. 2A, and the angle sensor 320-1, the motor driver circuit 370-1, and the motor 380-1 may be included in the second driving module 30b of FIG. 2A. Each “driving module” herein may comprise one or more of a sensor, a motor, and/or circuitry (e.g., see FIGS. 2A and 3A-3B).

According to an embodiment, the angle sensor 320 and the angle sensor 320-1 may each correspond to a hall sensor, but are not limited thereto.

According to an embodiment, the angle sensor 320 may measure or sense the angle of the first thigh frame 70a (or the angle of the first joint (e.g., left hip joint, etc.) of the user). The angle sensor 320 may transmit the measurement result (e.g., an angle value of the angle of the first thigh frame 70a) to the processor 310.

According to an embodiment, the angle sensor 320-1 may measure or sense the angle of the second thigh frame 70b (or the angle of the second joint (e.g., right hip joint) of the user). The angle sensor 320 may transmit the measurement result (e.g., an angle value of the angle of the second thigh frame 70b) to the processor 310.

According to an embodiment, the angle sensor 320 and the angle sensor 320-1 may additionally measure the knee angles and ankle angles of the user according to the positions of the angle sensor 320 and the angle sensor 320-1.

According to an embodiment, the wearable devices 300 and 300-1 may include a potentiometer. The potentiometer may sense an R-axis joint angle, an L-axis joint angle, an R-axis joint angular velocity, and an L-axis joint angular velocity according to a walking motion of the user. In this example, the R and L axes may be reference axes for the right leg and the left leg of the user, respectively. For example, the R/L axis may be set to be vertical to the ground and set such that a front side of a body of a person has a negative value and a rear side of the body has a positive value.

According to an embodiment, the PMIC 340 may charge the battery 330 using power supplied from an external power source. For example, the external power source and the wearable devices 300 and 300-1 may be connected through a cable (e.g., a universal serial bus (USB) cable, etc.). The PMIC 340 may receive power from the external power source through the cable, and charge the battery 330 using the received power. According to embodiments, the PMIC 340 may charge the battery 330 through a wireless charging method.

According to an embodiment, the PMIC 340 may transmit power stored in the battery 330 to a component (e.g., the processor 310, the memory 350, the IMU 360, the communication module 390, etc.) in the wearable device 300 or 300-1. The PMIC 340 may, for example, adjust the power stored in the battery 330 to a voltage or current level suitable for the components in the wearable device 300. The PMIC 340 may include, for example, a converter (e.g., a direct current (DC)-DC converter) or a regulator (e.g., a low-dropout (LDO) regulator or a switching regulator) configured to perform the adjustment described above.

According to an embodiment, the PMIC 340 may determine state information (e.g., a state of charge, a state of health, an overvoltage, a low voltage, an overcurrent, an overcharge, an overdischarge, an overheating, a short circuit, or a swelling) of the battery 330, and transmit the state information of the battery 330 to the processor 310. The processor 310 may control to provide the state information of the battery 330 to the user. For example, the processor 310 may output the status information of the battery 330 through at least one of a sound output module (e.g., a speaker), a vibration output module (e.g., a vibration motor or a haptic motor), or a display module (e.g., a display or the lighting unit 60). For example, the processor 310 may transmit the state information of the battery 330 to the electronic device 110 through the communication module 390, and the electronic device 110 may display the state information of the battery 330 on the display.

According to an embodiment, the IMU 360 may obtain motion information of the wearable device 300 or 300-1 (or the user). For example, the IMU 360 may obtain an acceleration value of each of three axes (e.g., the X, Y, and Z axes) of the wearable devices 300 and 300-1 (or the user), and may transmit the obtained acceleration value to the processor 310. The X-axis direction may be a front direction of the user, the Z-axis direction may be, for example, the direction of gravity, and the Y-axis direction may be a direction orthogonal to the X-axis and the Z-axis. The processor 310 may calculate the moving speed (e.g., the walking speed of the user) of the wearable devices 300 and 300-1 based on at least a portion (e.g., an acceleration value in the front direction) of the obtained acceleration value.

According to an embodiment, the processor 310 may control the overall operation of the wearable devices 300 and 300-1. The processor 310 may include processing circuitry.

According to an embodiment, the processor 310 may be operatively connected to at least one or all of the angle sensors 320 and 320-1, the memory 350, or the IMU 360.

According to an embodiment, the processor 310 may, for example, control the components (e.g., the motor driver circuits 370 and 370-1, etc.) in the wearable devices 300 and 300-1 by executing software (e.g., a program or instructions) stored in the memory 350, and perform various data processing or computation. As at least a portion of the data processing or computation, the processor 310 may store data received from other components (e.g., the IMU 360, the angle sensors 320 and 320-1, etc.) in the memory 350, and process the instructions or data stored in the memory 350.

According to an embodiment, the processor 310 may control the driving module 30 so that the driving module 30 provides (or outputs) a torque (e.g., a torque based on an angle value of the angle sensor 320 and/or 320-1) to the user. For example, the processor 310 may determine a torque value based on the angle value of the angle sensor 320 and/or 320-1 and an intensity level (e.g., a resistance intensity level or an assistance intensity level). The resistance intensity level may indicate an intensity level in a resistance mode, and the assistance intensity level may indicate an intensity level in an assistance mode. The processor 310 may control the driving module 30 based on the determined torque value. The driving module 30 may output a torque corresponding to the torque value. “Based on” as used herein covers based at least on.

According to an embodiment, the motor driver circuits 370 and 370-1 may respectively control the motors 380 and 380-1 under the control of the processor 310, and the motors 380 and 380-1 may respectively generate torques (e.g., resistance torques and/or assistance torques) by the control.

According to an embodiment, the communication module 390 may support establishment of a direct communication channel or a wireless communication channel between the wearable devices 300 and 300-1 and an external electronic device (e.g., the electronic device 110 of FIG. 1B or the other wearable device 130 of FIG. 1B) and communication therebetween via the established communication channel. The communication module 390 may include communication circuitry (e.g., Bluetooth communication circuitry, etc.).

According to an embodiment, the wearable devices 300 and 300-1 may include a display module. The display module may include, for example, a display and/or a lighting unit (e.g., the lighting unit 60 of FIG. 2A, comprising a light source). The processor 310 may control the display module so that the display module may provide visual feedback to the user.

According to an embodiment, the wearable devices 300 and 300-1 may include a sound output module. The sound output module may include, for example, one or more speakers. For example, a first speaker may be positioned, for example, in a housing including the first driving module 30a, and a second speaker may be positioned, for example, in a housing including the second driving module 30b.

According to an embodiment, the processor 310 may control a sound output module so that the sound output module may provide auditory feedback (or a voice) to the user. For example, the processor 310 may control the speaker to convert at least one sentence in a sentence group described below into voice through text-to-speech (TTS) and provide (or output) the voice to the user.

According to an embodiment, the wearable devices 300 and 300-1 may include a vibration output module. The vibration output module may include, for example, one or more vibration motors or one or more haptic motors. The processor 310 may control the vibration output module so that the vibration output module may provide tactile feedback (or haptic feedback) to the user.

According to an embodiment, at least one of the processor 310, the battery 330, the PMIC 340, the memory 350, the IMU 360, the communication module 390, or the display module, or a combination thereof may be positioned in the lumbar support frame 10 of FIGS. 2A and 2B.

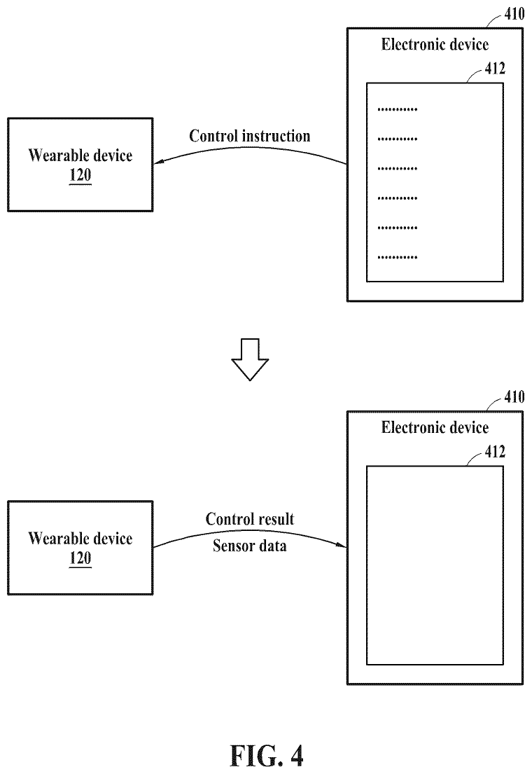

FIG. 4 is a diagram illustrating an interaction between a wearable device and an electronic device according to an example embodiment.

Referring to FIG. 4, the wearable device 120 may communicate with an electronic device 410 (e.g., the electronic device 110 of FIG. 1B or the other wearable device 130 of FIG. 1B). For example, the electronic device 410 may be a user terminal of the user who uses the wearable device 120 or a controller device, comprising processing circuitry, dedicated to the wearable device 120. According to an embodiment, the wearable device 120 and the electronic device 410 may be connected to each other via short-range wireless communication (e.g., Bluetooth™ or Wi-Fi communication).

According to an embodiment, the electronic device 410 may verify a state of the wearable device 120 or execute an application to control or operate the wearable device 120. A screen of a user interface (UI) may be displayed to control an operation of the wearable device 120 or determine an operation mode of the wearable device 120 on a display 412 of the electronic device 410 through the execution of the application. The UI may be, for example, a graphical user interface (GUI).

According to an embodiment, the user may input an instruction to control an operation of the wearable device 120 through the GUI screen on the display 212 of the electronic device 410 (e.g., an instruction to instruct the wearable device 120 to operate in an assistance mode of generating an assistance force or an instruction to instruct the wearable device 120 to operate in a resistance mode of generating a resistance force) or change the settings of the wearable device 120. The electronic device 410 may generate a control instruction (or control signal) corresponding to an operation control instruction or an instruction to change the settings input by the user and transmit the generated control instruction to the wearable device 120. The wearable device 120 may operate in response to the received control instruction and may transmit, to the electronic device 410, a control result in response to the control instruction and/or sensor data measured by a sensor (e.g., the angle sensors 320 and 320-1 and/or the IMU 360) of the wearable device 120. The electronic device 410 may provide the user with result information (e.g., walking ability information, exercise ability information, or exercise posture evaluation information) derived by analyzing the control result and/or the sensor data through the GUI screen.

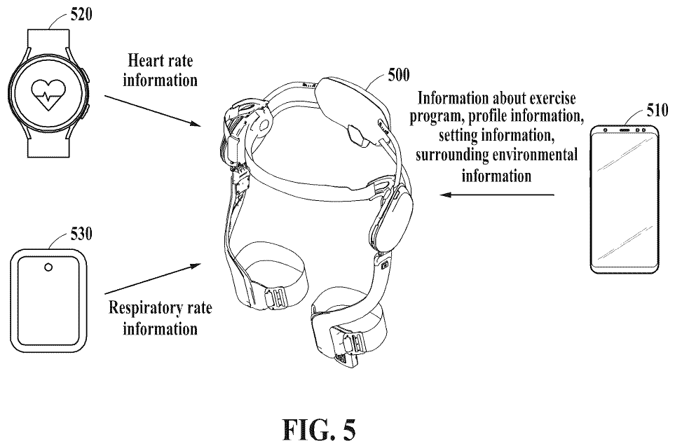

FIG. 5 is a diagram illustrating an example of communication between a wearable device and one or more electronic devices according to an example embodiment.

Referring to FIG. 5, a wearable device 500 (e.g., the wearable device 120 of FIGS. 1A and 1B, the wearable device 200 of FIGS. 2A and 2B, the wearable device 300 of FIG. 3A, and the wearable device 300-1 of FIG. 3B) according to an embodiment may communicate with an electronic device 510 (e.g., the electronic device 110 of FIG. 1B and the electronic device 410 of FIG. 4).

According to an embodiment, the electronic device 510 may receive, from the user, at least one of the profile information (e.g., the age) of the user, information about an exercise program (e.g., the type of exercise program selected by the user) to be performed by the user, or surrounding environmental information (e.g., information about whether the environment in which the exercise of the user is performed is indoors or outdoors) of the user.

According to an embodiment, the electronic device 510 may receive, from the user, information (e.g., information indicating that the user selects the assistance mode to be the operation mode of the wearable device 500 or information indicating that the user selects the resistance mode to be the operation mode of the wearable device 500) about an operation mode (e.g., the assistance mode or the resistance mode) of the wearable device 500 and the intensity level related to the magnitude of the torque of the wearable device 500. The information about the operation mode of the wearable device 500 and the intensity level may correspond to, for example, settings information that is set to the wearable device 500 to generate the torque (e.g., the assistance torque or the resistance torque).

According to an embodiment, the wearable device 500 may receive, from the electronic device 510, at least one of the information about the exercise program, the profile information of the user, the settings information (e.g., the information about the operation mode of the wearable device 500 and the intensity level) of the wearable device 500, or the surrounding environmental information of the user, or a combination thereof.

According to an embodiment, the wearable device 500 may establish a wireless communication link (e.g., the Bluetooth link) with a watch-type electronic device (or a smartwatch) 520 (e.g., the smartwatch 132 of FIG. 1B). The wearable device 500 may receive heart rate information of the user from the watch-type electronic device 520.

According to an embodiment, the wearable device 500 may establish the wireless communication link (e.g., the Bluetooth link) with an electronic device 530 that may measure a respiratory rate of the user and may receive respiratory rate information of the user from the electronic device 530.

Depending on the implementation, the wearable device 500 may receive, from the user, at least one of the information about the exercise program, the profile information of the user, the settings information of the wearable device 500, or the surrounding environmental information of the user, or a combination thereof.

According to an embodiment, the wearable device 500 may provide a voice (e.g., a voice generated based on a sentence in a sentence group described below) to the user. When the wearable device 500 does not establish a wireless communication link (e.g., the Bluetooth link) with the wireless earphones 131, the wearable device 500 may provide the voice to the user through one or more speakers. When the wearable device 500 establishes the wireless communication link with the wireless earphones 131, the wearable device 500 may transmit the voice to the wireless earphones 131. The wireless earphones 131 may provide the voice received from the wearable device 500 to the user.

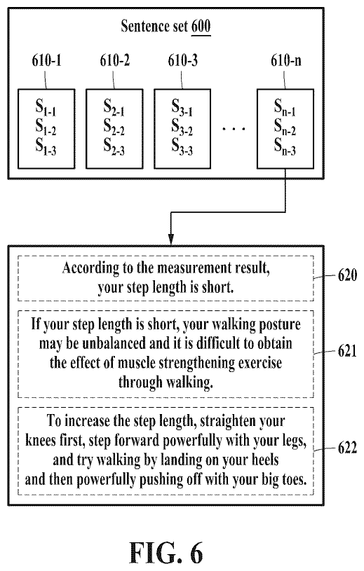

FIG. 6 is a diagram illustrating a sentence set and sentence groups included in the sentence set according to an example embodiment.

Referring to FIG. 6, an example of a sentence set 600 according to an embodiment is illustrated.

According to an embodiment, the sentence set 600 may be, for example, a sentence set specified for an exercise program (e.g., an exercise program to be performed by the user or an exercise program selected by the user) or a sentence set mapped to the exercise program. The sentence set 600 may correspond to a set of sentence groups 610-1 to 610-n that may be provided to the user as the voice of the wearable device 500 while the user performs exercise according to the exercise program. As described below, according to a given condition (e.g., the age of the user, etc.), some of the sentence groups 610-1 to 610-n may not be selected and may not be provided to the user.

According to an embodiment, the sentence set 600 may be stored in the memory 350 of the wearable device 500. However, the example is not limited thereto, and the sentence set 600 may be stored in the electronic device 110, 410, or 510. The wearable device 500 may receive the sentence set 600 together with the information about the exercise program to be performed by the user from the electronic device 110, 410, or 510.

According to an embodiment, the sentence set 600 may include a plurality of sentence groups 610-1 to 610-n. Each of the sentence groups 610-1 to 610-n may include at least one sentence. Each of the sentence groups 610-1 to 610-n may include up to three sentences. The maximum number of sentences included in each of the sentence groups 610-1 to 610-n is not limited to 3, and each of the sentence groups 610-1 to 610-n may include three or more sentences.

According to an embodiment, the sentences included in the sentence groups 610-1 to 610-n may have a correlation (e.g., a contextual correlation, etc.). In the example shown in FIG. 6, the sentence group 610-1 may include sentences S1-1, S1-2, and S1-3, and the sentences S1-1, S1-2, and S1-3 may have a correlation (e.g., the contextual correlation, etc.). The sentence group 610-2 may include sentences S2-1, S2-2, and S2-3, and the sentences S2-1, S2-2, and S2-3 may have a correlation (e.g., the contextual correlation, etc.). The sentence group 610-3 may include sentences S3-1, S3-2, and S3-3, and the sentences S3-1, S3-2, and S3-3 may have a correlation (e.g., the contextual correlation, etc.). The sentence group 610-n may include sentences Sn-1, Sn-2, and Sn-3, and the sentences Sn-1, Sn-2, and Sn-3 may have a correlation (e.g., the contextual correlation, etc.). FIG. 6 illustrates an example 620 of the sentence Sn-1 of the sentence group 610-n, an example 621 of the sentence Sn-2, and an example 622 of the sentence Sn-3. As shown in FIG. 6, the sentences 620, 621, and 622 may have the contextual correlation about a step length of the user.

According to an embodiment, when a sentence group includes a plurality of sentences, one of the plurality of sentences may be a key sentence (or a main sentence or a core sentence) and the others may be additional explanation sentences (or sub-sentences). The key sentence (or the main sentence or the core sentence) may indicate a sentence that is not able to be omitted from the sentence group, and the additional explanation sentence (or a sub-sentence) may be a sentence that may be omitted from the sentence group. In the example shown in FIG. 6, the sentence 620 may be the key sentence (or the main sentence), and the sentences 621 and 622 may be additional explanation sentences (or the sub-sentences). As described below, the wearable device 500 may omit some sentences of the sentence group to reduce the amount of speech (speech amount) of the wearable device 500. In this case, the wearable device 500 may not omit the key sentence and may omit the additional explanation sentence from the sentence group. The speech amount of the wearable device 500 may indicate, for example, how much speech the wearable device 500 provides.

According to an embodiment, each of the sentence groups 610-1 to 610-n may have a sentence type. The sentence groups 610-1 to 610-n may be classified based on sentence types. The sentence types may include, for example, a notice (N) type, an information (I) type, a coaching (C) type, and an emotion (E) type. The N type may indicate, for example, a sentence type for at least one of a usage guide (e.g., usage guide for an exercise program, etc.), a guide to the order of the exercise program of the user, or a notification of a state of the wearable device 500. The I type may indicate, for example, a sentence type for conveying at least one of an exercise result of the user or exercise knowledge. The C type may indicate, for example, a sentence type for at least one of coaching the exercise of the user, a comment about the exercise of the user, an advice about the exercise of the user, or encouraging the user. The E type may indicate, for example, a sentence type for at least one of greeting, encouragement, or praise for the user.

Table 1 below shows example sentences of each sentence type.

TABLE 1

| Sen- | |
|---|---|
| tence | |
| Type | Sentences |
| N type | 1. Power walking is an exercise that maintains a fast pace |
| | while alternating between an aqua mode and a boost mode. |
| | 2. I'll find out what exercise is best for you after simple |
| | measurement. To continue, press start. |
| | 3. The battery is low. Less than 30%. |
| Type I | 1. I'll tell you the result of this exercise. You walked a total of |
| | 10,271 steps at an average of 8 km/h and burned 120 kcal. You |
| | gained 15% of robot effect while walking with me. |
| | 2. Cardiorespiratory endurance is also called whole body |
| | endurance. It is the ability to help provide various nutrients to |
| | muscles and remove waste products generated after exercise. |
| C type | 1. Lift your knee slightly higher. Your step length will increase. |
| | 2. The speed is still slower than the target speed. Speed up. |
| | 3. It might be difficult but don't give up and let's get through it! |
| E type | 1. Hello? I'm a robot trainer to assist you with your exercise. |
| | Nice to work out with you! |
| | 2. How were you feeling after the exercise yesterday? Don't |
| | forget to stretch to prevent muscle cramps. |
| | 3. What an amazing development! If you win a walking |
| | competition later, don't forget to shout out my name! |
| | 4. Applause for your tireless passion. I need to work harder, too! |

For example, the sentence group 610-1 may be I type and may include the sentence S1-1 (e.g., I'll tell you the result of this exercise), the sentence S1-2 (e.g., You walked a total of 10,271 steps at an average of 8 km/h and burned 120 kcal), and the sentence S1-3 (e.g., You gained 15% of robot effect while walking with me). As described above, the sentences S1-1, S1-2, and S1-3 in the sentence group 610-1 may have the contextual correlation on the result of the user's exercise.

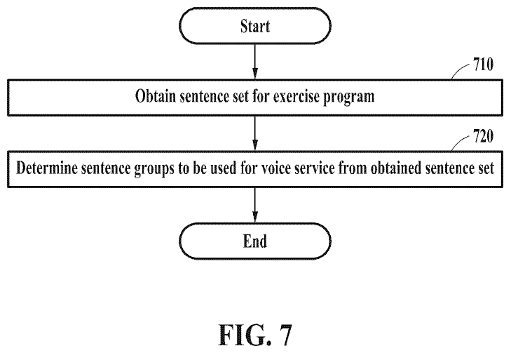

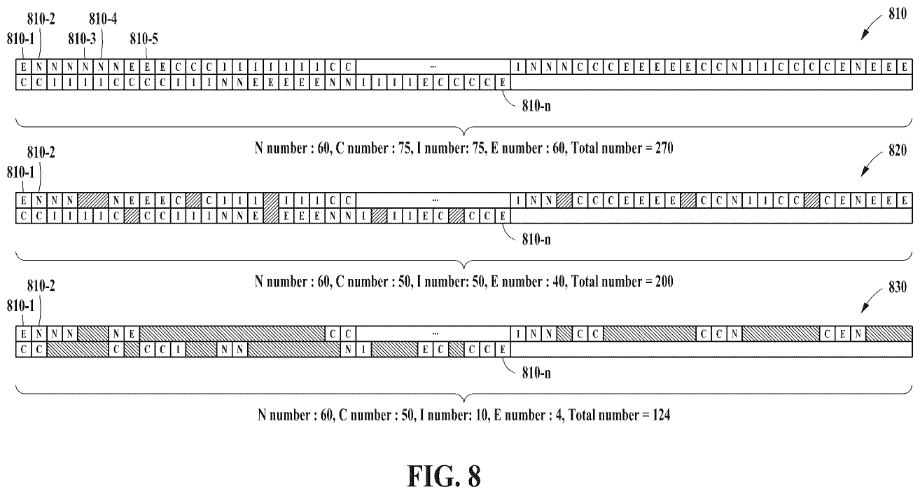

According to an embodiment, some of the sentence groups 610-1 to 610-n may have attribute information about possible omission. As described below with reference to FIGS. 7 and 8, the wearable device 500 may select a selection state for the sentence set 600 to be a first selection state, a second selection state, or a third selection state. The first selection state may indicate, for example, a state in which the wearable device 500 selects all of the sentence groups 610-1 to 610-n in the sentence set 600, and the second and third selection states may indicate, for example, a state in which the wearable device 500 selects some of the sentence groups 610-1 to 610-n. Fewer sentence groups may be selected in the third selection state than in the second selection state. At least some of the sentence groups 610-1 to 610-n may have first attribute information indicating that at least some of the sentence groups 610-1 to 610-n are omitted in the second selection state, and at least some of the sentence groups 610-1 to 610-n may have second attribute information indicating that at least some of the sentence groups 610-1 to 610-n are omitted in the third selection state. The sentence group having the first attribute information may have the second attribute information. A sentence group may have both the first attribute information and the second attribute information. When the wearable device 500 determines a selection state for the sentence set 600 to be the second selection state, the wearable device 500 may not select a sentence group having the first attribute information from the sentence groups 610-1 to 610-n. When the wearable device 500 determines a selection state for the sentence set 600 to be the third selection state, the wearable device 500 may not select a sentence group having the second attribute information from the sentence groups 610-1 to 610-n. When the wearable device 500 determines a selection state for the sentence set 600 to be the first selection state, the wearable device 500 may select all of the sentence groups 610-1 to 610-n.

FIGS. 7 and 8 are diagrams illustrating examples of a method of adjusting the amount of speech by a wearable device according to an example embodiment.

Referring to FIG. 7, in operation 710, the wearable device 500 (e.g., the processor 310) may obtain a sentence set (e.g., the sentence set 600 of FIG. 6 and a sentence set 810 of FIG. 8) for an exercise program. For example, sentence sets respectively for a plurality of exercise programs (e.g., an interval walking exercise program, a power walking exercise program, etc.) may be stored in the memory 350 of the wearable device 500. When an exercise program is selected (or when receiving information about an exercise program selected by the user from the electronic device 510), the processor 310 of the wearable device 500 may obtain (or receive) a sentence set for the selected exercise program from the memory 350.

According to an embodiment, the processor 310 may obtain a sentence set (e.g., the sentence set 600 of FIG. 6 and the sentence set 810 of FIG. 8) for the selected exercise program. The sentence set 810 shown in FIG. 8 may include a plurality of sentence groups 810-1, 810-2, . . . , 810-n (e.g., 270 sentence groups). The sentence set 810 may include sentence groups of the N type, sentence groups of the C type, sentence groups of the I type, and sentence groups of the E type. In the sentence set 810, the number of sentence groups of the N type may be 60, the number of sentence groups of the C type may be 75, the number of sentence groups of the I type may be 75, and the number of sentence groups of the E type may be 60.

In the example shown in FIG. 8, the sentence groups 810-3 and 810-4 may have the first attribute information (e.g., information indicating a sentence group that may be omitted in the second selection state) and the second attribute information (e.g., information indicating a sentence group that may be omitted in the third selection state), and the sentence group 810-5 may have the second attribute information. The sentence groups 810-1, 810-2, and 810-n may not have the first attribute information and the second attribute information.

In operation 720, the wearable device 500 (e.g., the processor 310) may determine (or select) sentence groups to be used for a voice service of the wearable device 500 from the obtained sentence set (e.g., the sentence set 810 of FIG. 8). The processor 310 may determine (or select) the sentence groups to be used for the voice service of the wearable device 500 from the sentence set (e.g., the sentence set 810 of FIG. 8) for the exercise program, based on at least one of the profile information (e.g., the age) of the user, the surrounding environmental information of the user (e.g., information about whether an environment in which the exercise of the user is performed is indoors or outdoors), or information about whether an electronic device (e.g., the electronic device including a display for displaying visual data) that establishes a wireless communication link with the wearable device 500 exists.

Since an old user may have decreased cognitive function and hearing ability, the language processing ability (e.g., the ability to understand a voice of the wearable device 500) of the old user may be degraded. When the user receives data as a voice, the burden on the user's short-term memory and concentration may increase compared to when the user visually views the data. Due to this, the language processing ability of the user may be relatively higher when the data is visually provided to the user (or is provided both visually and auditorily) compared to when the data is provided to the user as a voice. In the case of outdoor exercise (e.g., outdoor walking exercise), the user may need to check a path and an exercise hindering factor (e.g., an obstacle) while walking, but in the case of indoor exercise, there may be less ambient noise and less exercise hindering factors, and thus, the language processing ability of the user during the indoor exercise may be different from the language processing ability of the user during the outdoor exercise.

The wearable device 500 (e.g., the processor 310) may determine the level of the language processing ability of the user (e.g., the user before starting the exercise) based on at least one of the profile information (e.g., the age) of the user, the surrounding environmental information (e.g., the information about whether the environment in which the exercise of the user is performed is indoors or outdoors), or whether there is an electronic device (e.g., an electronic device including a display for displaying visual data) that establishes the wireless communication link with the wearable device 500, and may determine (or select) sentence groups used for the voice service from the sentence set for the exercise program. When the wearable device 500 (e.g., the processor 310) determines that the level of the language processing ability is relatively low, the wearable device 500 may select fewer sentence groups from the sentence set for the exercise program.

For example, when the environment in which the exercise of the user is performed is indoors (or the exercise of the user is an indoor exercise), the processor 310 may determine that the level of the language processing ability of the user (e.g., the user before starting the exercise) to be a first level (e.g., the level of the language processing ability is relatively high). The processor 310 may select all of the sentence groups 810-1 to 810-n in the sentence set 810 for the exercise program. When the environment in which the exercise of the user is performed is indoors, the processor 310 may determine the selection state for the sentence set 810 to be the first selection state and may select all of the sentence groups 810-1 to 810-n in the sentence set 810.

For example, when the age of the user is less than a determined level (e.g., 70 years old), when there is an electronic device that establishes a wireless communication link with the wearable device 500, or when the environment in which the exercise of the user is performed is outdoors (or the exercise of the user is an outdoor exercise), the processor 310 may determine that the language processing ability of the user (e.g., the user before starting the exercise) is a second level (e.g., a level lower than the first level). In this case, the processor 310 may select first sentence groups 820 from the sentence groups of the sentence set 810 for the exercise program. When the age of the user is less than the determined level (e.g., 70 years old), when there is an electronic device that establishes the wireless communication link with the wearable device 500, or when the environment in which the exercise of the user is performed is outdoors, the processor 310 may determine the selection state for the sentence set 810 to be the second selection state. When the processor 310 determines that the selection state for the sentence set 810 is the second selection state, the processor 310 may not select a sentence group having the first attribute information from the sentence groups of the sentence set 810. Since the sentence group 810-3 and the sentence group 810-4 may have the first attribute information, when the processor 310 determines the selection state for the sentence set 810 to be the second selection state, the processor 310 may not select the sentence groups 810-3 and 810-4. The processor 310 may select sentence groups (e.g., the first sentence groups 820) having the first attribute information. In FIG. 8, “ [symbol] ” may indicate a sentence group (or a sentence group having the first attribute information) that is not selected in the second selection state. Depending on the implementation, when the age of the user is a determined level or above and the environment in which the exercise of the user is performed is indoors, the processor 310 may select the first sentence groups 820 from the sentence groups of the sentence set 810. When there is no electronic device that establishes a wireless communication link with the wearable device 500 and the exercise of the user is an indoor exercise, the processor 310 may select the first sentence groups 820 from the sentence groups of the sentence set 810.

In another example, when the age of the user is the determined level or above or there is no electronic device (e.g., the electronic device 510 and/or 520 including a display) that establishes the wireless communication link with the wearable device 500, the processor 310 may determine that the level of the language processing ability of the user (e.g., the user before starting the exercise) is a third level (e.g., a level lower than the second level). In this case, the processor 310 may select second sentence groups 830 from the sentence groups of the sentence set 810 for the exercise program. In this case, the number of second sentence groups 830 may be less than the number of first sentence groups 820. When the age of the user is the determined level or above or there is no electronic device that establishes the wireless communication link with the wearable device 500, the processor 310 may select the selection state for the sentence set 810 to be the third selection state. The processor 310 may not select a sentence group having the second attribute information from the sentence groups of the sentence set 810. Since the sentence groups 810-3, 810-4, and 810-5 may have the second attribute information, the processor 310 may not select the sentence groups 810-3, 810-4, and 810-5. The processor 310 may select sentence groups (e.g., the second sentence groups 830) that do not have the second attribute information. In FIG. 8, “ [symbol] ” may indicate a sentence group (or a sentence group having the second attribute information) that is not selected in the third selection state.

The wearable device 500 may determine that the language processing ability of the user is degraded when the age of the user is a determined level or above or the electronic device (e.g. an electronic device including a display for displaying visual data) is not connected to the wearable device 500. Based on the determination, the wearable device 500 may select the second sentence groups 830 from the sentence groups of the sentence set (e.g., the sentence set 810 of FIG. 8) for the exercise program to adjust (e.g., reduce) the speech amount of the wearable device 500.

According to an embodiment, a rate at which the sentence group is selected from the sentence set 810 (hereinafter, also referred to as the “selection rate”) may vary depending on the selection state and the type of the sentence group. Table 2 below shows an example of the selection rate according to the selection state and the sentence type.

TABLE 2

| | Selection rate in | Selection rate in | Selection rate in |
|---|---|---|---|
| Sentence | third selection | second selection | first selection |
| Type | state | state | state |
| N type | 100% | 100% | 100% |
| Type I | 13.3% | 66.6% | 100% |
| C type | 66.6% | 66.6% | 100% |
| E type | 6.66% | 66.6% | 100% |

In the first selection state, a selection rate of each type may be 100%. In the first selection state, the wearable device 500 may select all sentence types of each type from the sentence set 810.

In the second selection state, a selection rate of the N type may be 100%. In the second selection state, the wearable device 500 may select all sentence groups of the N type from the sentence set 810. In the second selection state, the selection rates of the I, C, and E types may be 66.6%, respectively. In the second selection state, the wearable device 500 may select 66.6% of sentence groups (e.g., 50 sentence groups) from the sentence groups (e.g., 75 sentence groups of the I type in the sentence set 810) of the I type, may select 66.6% of sentence groups (e.g., 50 sentence groups) from the sentence groups (e.g., 75 sentence groups of the C type in the sentence set 810) of the C type, and may select 66.6% of sentence groups (e.g., 40 sentence groups) from the sentence groups (e.g., 60 sentence groups of the E type in the sentence set 810) of the E type.

In the third selection state, a selection rate of the N type may be 100%. In the third selection state, the wearable device 500 may select all sentence groups of the N type from the sentence set 810. In the third selection state, the selection rate of the I type may be 13.3%, the selection rate of the C type may be 66.6%, and the selection rate of the E type may be 6.66%. In the third selection state, the wearable device 500 may select 13.3% of sentence groups (e.g., 10 sentence groups) from the sentence groups (e.g., 75 sentence groups of the I type in the sentence set 810) of the I type, may select 66.6% of sentence groups (e.g., 50 sentence groups) from the sentence groups (e.g., 75 sentence groups of the C type in the sentence set 810) of the C type, and may select 6.66% of sentence groups (e.g., 4 sentence groups) from the sentence groups (e.g., 60 sentence groups of the E type in the sentence set 810) of the E type.

The characteristics (e.g., necessity, memory burden, and helpfulness) may vary depending on the type of the sentence group, and the number (or the selection rate) of selected sentence groups may also vary depending on the characteristics. The necessity may indicate, for example, a degree to which the sentence group (or the sentence) is necessary for the exercise of the user, the memory burden may indicate, for example, a degree to which the user has difficulty remembering the sentence group (or the sentence), and the helpfulness may indicate, for example, a degree to which the sentence group (or the sentence) is helpful for the exercise of the user.

Table 3 below shows an example of necessity, memory burden, and helpfulness by each type.

TABLE 3

| Sentence | | | |
|---|---|---|---|
| Type | Necessity | Memory burden | Helpfulness |
| N type | High | Medium | Medium |
| Type I | Low | High | High |
| C type | High | Low | High |
| E type | Low | Low | High |

According to an embodiment, as the helpfulness increases, more sentence groups may be selected, and as the necessity and the memory burden decrease, fewer sentence groups may be selected. For example, since the necessity of the sentence group of the I type is low, but the memory burden thereof is high, the number (or the selection rate) of sentence groups selected in the third selection state may be relatively small.

According to an embodiment, one sentence group may correspond to a single speech of the wearable device 500. A speech for one sentence group may be the single speech. As the number of sentence groups increases, the speech frequency (or the number of speeches) of the wearable device 500 may increase, and as the number of sentence groups decreases, the speech frequency (or the number of speeches) of the wearable device 500 may decrease. The wearable device 500 may decrease the speech amount of the wearable device 500 by reducing the number of sentence groups by considering the age of the user and the like.

According to an embodiment, the operations of the wearable device 500 described with reference to FIGS. 7 and 8 may be performed by the electronic device 510. For example, the electronic device 510 may perform operations 710 and 720 described with reference to FIG. 7. The electronic device 510 may obtain a sentence set for an exercise program and may determine sentence groups (e.g., all sentence groups of the sentence set 810, the first sentence groups 820, or the second sentence groups 830 of FIG. 8) used for the voice service from the obtained sentence set. The electronic device 510 may transmit the determined sentence groups to the wearable device 500.

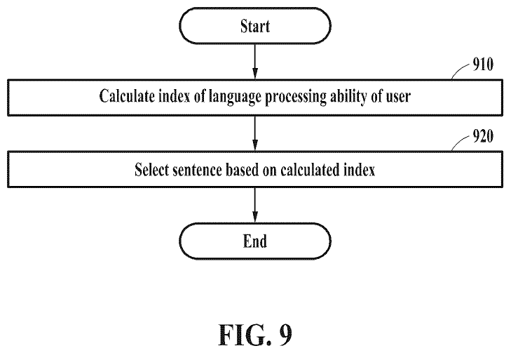

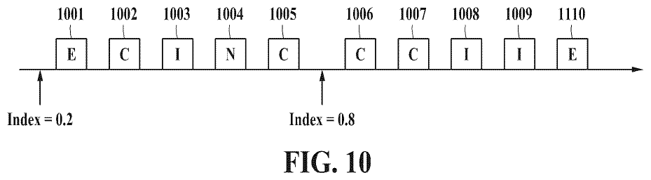

FIGS. 9 and 10 are diagrams illustrating an example of adjusting the amount of speech by a wearable device based on an index calculated during an exercise of a user according to an example embodiment.

Referring to FIG. 9, in operation 910, the wearable device 500 (e.g., the processor 310) may calculate (or obtain) an index related to a language processing ability (or a degree of burden on the body of the user) of a user (e.g., the user performing the exercise).

According to an embodiment, the language processing ability may include, for example, an ability of the user to understand a voice (or a sentence spoken by the wearable device 500) of the wearable device 500. When biometric information (e.g., a heart rate and/or respiration) of the user reaches a threshold (or when the degree of the burden on the user's body is high due to the exercise), the user may have difficulty in accepting information (e.g., voice information, etc.) at a determined level or above, and the capacity of the user to process the voice information may decrease. When the biometric information (e.g., the heart rate and/or respiration) of the user is stable (or when the burden on the user's body is low), the user may easily process the voice information. The wearable device 500 may calculate an index that quantifies the language processing ability (e.g., or the degree of the burden on the user's body) of the user to determine whether the language processing ability of the user has decreased (or whether the degree of the burden on the user's body is high) during the exercise. The index may be referred to as, for example, language processing ability saturation (LPAS).

According to an embodiment, the wearable device 500 (e.g., the processor 310) may calculate (or obtain) the index of the language processing ability (or the degree of the burden on the user's body) of the user based on at least one of the exercise information on the exercise of the user, the biometric information of the user, or the settings information (e.g., the information on the operation mode of the wearable device 500 and the intensity level) of the wearable device 500. As a value of the index of the language processing ability (or the degree of the burden on the user's body) increases, the language processing ability of the user during the exercise may be degraded (or the burden on the user's body is high). As the value of the index of the language processing ability (or the degree of the burden on the user's body) decreases, the language processing ability of the user during the exercise may not be degraded (or the burden on the user's body is low).

For example, the processor 310 may calculate (or obtain) the index of the language processing ability (or the degree of the burden on the user's body) of the user through Equation 1 below.

$$Index = \frac{{\sum }_{i = 1}^{4} {w}_{i} {v}_{i}}{{\sum }_{i = 1}^{4} {w}_{i}} \qquad [ Equation l ]$$

In Equation 1 above, v₁ may denote a normalized value of an increment of a heart rate of a user, and v₂ may denote a normalized value of an increment of a respiratory rate per minute of the user. v₃ may denote a value determined based on the moving speed (e.g., the walking speed) of the user, and v₄ may denote a value determined based on the settings information (e.g., the information on the operation mode of the wearable device 500 and the intensity level) of the wearable device 500.

In Equation 1 above, w₁ to w₄ may denote weights of v₁ to v₄, respectively.

The processor 310 may determine (or calculate) v₃ and v₄ by using Table 4 below.

TABLE 4

| Moving speed | Settings information | Value |
|---|---|---|
| 21 km/h or above | Resistance mode/Intensity level = 5 | 1 |
| 17 to 20 km/h | Resistance mode/Intensity level = 3 to | 0.8 |
| | 4 | |
| 13 to 16 km/h | Resistance mode/Intensity level = 1 to | 0.6 |
| | 2 | |
| 9 to 12 km/h | Assistance mode/Intensity level = 0 to | 0.4 |
| | 1 | |
| 5 to 8 km/h | Assistance mode/Intensity level = 2 to | 0.2 |
| | 3 | |
| 0 to 4 km/h | Assistance mode/Intensity level = 4 to | 0.0 |
| | 5 | |

When the moving speed of the user is 3 km/h, the processor 310 may determine v₃ to be “0”, and when the settings information of the wearable device 500 is the resistance mode and the intensity level is 2, the processor 310 may determine v₄ to be 0.6.

The processor 310 may calculate the normalized value of the increment of the heart rate according to “(measured heart rate-reference heart rate)/(maximum heart rate-reference heart rate)”. The processor 310 may receive the measured heart rate from the watch-type electronic device 520. The reference heart rate may indicate, for example, an average of heart rates that are measured during a warm-up of the exercise program. The maximum heart rate may be a statistical value (e.g., 210) of the maximum heart rate of an adult male or the maximum heart rate obtained from the exercise history of the user.

The processor 310 may calculate a normalized value of the respiratory rate per minute according to “(measured respiratory rate per minute-reference respiratory rate per minute)/(maximum respiratory rate per minute-reference respiratory rate per minute)”. The processor 310 may receive the measured respiratory rate per minute from the electronic device 530. The reference respiratory rate per minute may indicate, for example, an average of respiratory rates measured during a warm-up of the exercise program. The maximum respiratory rate per minute may be, for example, a statistical value (e.g., 60) of the maximum respiratory rate per minute of an adult male or the maximum respiratory rate per minute obtained from the exercise history of the user.

The measured heart rate may be 195, the reference heart rate may be 70, the normalized value of the increment of the heart rate may be 0.89, the reference respiratory rate may be 16, the normalized value of the variance of the respiratory rate may be 0.89, v₃ may be 0.6, v₄ may be 0.4, w₁ may be 5, w₂ may be 3, w₃ may be 1, and w₄ may be 1. In this case, the processor 310 may calculate the index to be 0.81 according to Equation 1 above.

In another example, the processor 310 may calculate (or obtain) an index of the language processing ability (or the degree of the burden on the user's body) of the user through Equation 2 below.

$$Index = \frac{{w}_{1} {v}_{1} + {w}_{2} {v}_{2}}{{w}_{1} + {w}_{2}} \qquad [ Equation 2 ]$$

In Equation 2, v₁ may denote a normalized value of an increment of the heart rate of the user, v₂ may denote a normalized value of the increment of the respiratory rate per minute of the user, and w₁ and w₂ may denote weights of v₁ and v₂, respectively.

In another example, the processor 310 may calculate an index of the language processing ability (or the degree of the burden on the user's body) of the user through Equation 3 below.

$$Index = \frac{{w}_{1} {v}_{1} + {w}_{2} {v}_{2} + {w}_{α} {v}_{α}}{{w}_{3} + {w}_{4} + {w}_{α}} \qquad [ Equation 3 ]$$

In Equation 3, v₃ may denote a value determined based on the moving speed (e.g., walking speed) of the user, v₄ may denote a value determined based on the settings information (e.g., the information about the operation mode of the wearable device 500 and the intensity level) of the wearable device 500, and v_{α} may denote an estimated value of the biometric information (e.g., the heart rate and/or the respiratory rate per minute) of the user. w₃, w₄, and w_{α} may denote weights of v₃, v₄, and v_{α}, respectively. The estimated value of the biometric information of the user may be calculated, for example, based on at least one of the exercise time of the user, the moving speed (e.g., the walking speed) of the user, or the torque magnitude of the wearable device 500.

In another example, the processor 310 may calculate (or obtain) the index of the language processing ability (or the degree of the burden on the user's body) of the user based on a variance of the exercise posture of the user and/or a variance of a coaching adherence rate. The processor 310 may determine (or estimate) an exercise posture (e.g., a walking posture) of the user by using sensing data of the IMU 360. For example, the processor 310 may determine that the exercise posture of the user is a first posture (e.g., a posture in which the waist is bent forward) or a second posture (e.g., a posture in which the user sways from side to side) by using the sensing data of the IMU 360. In this case, since the processor 310 may determine that the burden on the user's body is a determined level or above, the processor 310 may calculate the index of the language processing ability (or the degree of the burden on the user's body) to be high. The processor 310 may determine whether the exercise posture (e.g., gait symmetry) of the user deviates from a balance range. The gait symmetry may be, for example, a value indicating a degree of symmetry between a gait by a right leg of the user and a gait by a left leg of the user. When a time period in which the exercise posture (e.g., the gait symmetry) deviates from the balance range maintains a determined time period or more, the processor 310 may determine that the burden on the user's body is greater than or equal to a determined level and may thus calculate the index of the language processing ability (or the degree of the burden on the user's body) to be high. In another example, the processor 310 may calculate a coaching compliance rate indicating the degree to which the exercise of the user achieves a goal while the user performs the exercise. The processor 310 may calculate the coaching compliance rate of the user at a determined time point after beginning the exercise and may calculate a variance of the coaching compliance rates through calculated coaching compliance rates. When the variance of the coaching compliance rate is less than or equal to a threshold level, the processor 310 may determine that the burden on the user's body is greater than or equal to a determined level and may thus calculate the index of the language processing ability (or the degree of the burden on the user's body) to be high.

In another example, when calculating the index of the language processing ability (or the degree of the burden on the user's body) through Equation 1, Equation 2, or Equation 3 above, the processor 310 may further use the variance of the exercise posture of the user and/or the variance of the coaching compliance rate.

In operation 920, the wearable device 500 (e.g., the processor 310) may select a sentence (e.g., a sentence to be used for voice generation or a speech of the wearable device 500) based on the calculated index.

For example, all of the sentence groups 610-1 to 610-n in the sentence set 600 of FIG. 6 may be determined to be the sentence groups to be used for the voice service. After the processor 310 calculates the index, the order of speech of the sentence group 610-2 may arrive. When the calculated index exceeds a first range (e.g., 0.3 to 0.7) or the calculated index exceeds a first threshold value (e.g., 0.7), the processor 310 may select sentences in the sentence group 610-2 (or select a key sentence and two or more additional explanation sentences). When the calculated index exceeds the first range, the processor 310 may select a third number (e.g., three) of sentences (e.g., the key sentence and two additional explanation sentences) from the sentence group 610-2. When the calculated index falls in the first range (e.g., 0.3 to 0.7) or the calculated index is less than or equal to the first threshold value (e.g., 0.7) and greater than or equal to a second threshold value (e.g., 0.3), the processor 310 may select some (e.g., the key sentence and one or more additional explanation sentences) of the sentences in the sentence group 610-2. When the calculated index falls in the first range (e.g., 0.3 to 0.7), the processor 310 may select a second number (e.g., two) of sentences (e.g., the key sentence and the additional explanation sentence) from the sentence group 610-2. When the calculated index is less than the first range (e.g., 0.3 to 0.7) or the calculated index is less than the second threshold value (e.g., 0.3), the processor 310 may select one (e.g., the key sentence) from the sentences in the sentence group 610-2. When the calculated index is less than the first range, the processor 310 may select a first number (e.g., one) of sentences (e.g., the key sentence) from the sentence group 610-2.

The first number may be less than the second number, and the third number may be greater than the second number.

The wearable device 500 (e.g., the processor 310) may generate a voice based on the selected sentence and may provide the generated voice to the user. For example, when the processor 310 selects a key sentence and two additional explanation sentences from the sentence group 610-2, the processor 310 may generate a voice based on the key sentence and the two additional explanation sentences. The processor 310 may convert the key sentence and the two additional explanation sentences into a voice through TTS or a generative model. The processor 310 may control a speaker to provide the voice to the user.

According to an embodiment, the number of selected sentences may vary depending on the type of sentence group and the calculated index. Table 5 below shows an example of the number of selected sentences according to each type of sentence group and the calculated index.

TABLE 5

| Sentence | When index is less | When index falls | When index |
|---|---|---|---|
| Type | than first range | in first range | exceeds first range |
| N type | 2 (key sentence + | 2 (key sentence + | 2 (key sentence + |
| | additional | additional | additional |
| | explanation | explanation | explanation |
| | sentence) | sentence) | sentence) |
| Type I | 1 (key sentence) | 2 (key sentence + | 3 (key sentence + |
| | | additional | additional |
| | | explanation | explanation |
| | | sentence) | sentence 1 + |
| | | | additional |
| | | | explanation |
| | | | sentence 2) |
| C type | 1 (key sentence) | 1 (key sentence) | 2 (key sentence + |
| | | | additional |
| | | | explanation |
| | | | sentence) |
| E type | 1 (key sentence) | 1 (key sentence) | 3 (key sentence + |
| | | | additional |
| | | | explanation |
| | | | sentence 1 + |
| | | | additional |
| | | | explanation |
| | | | sentence 2) |

According to an embodiment, as the helpfulness of Table 3 above increases, more sentences may be selected, and as the necessity and the memory burden decrease, fewer sentences may be selected. For example, since the sentence group of the I type may have low necessity and high memory burden, when the index is less than the first range, one sentence may be selected from the sentence group of the I type, and when the index falls in the first range, two sentences may be selected from the sentence group of the I type. Since the helpfulness of the sentence group of the I type may be high, when the index exceeds the first range, three sentences may be selected from the sentence group of the I type. Since the necessity and memory burden of the sentence group of the E type may be low, when the index is less than the first range or the index falls in the first range, one sentence may be selected from the sentence group of the E type. Since the helpfulness of the sentence group of the E type may be high, when the index exceeds the first range, three sentences may be selected from the sentence group of the E type.

According to an embodiment, the wearable device 500 (e.g., the processor 310) may periodically update (or calculate) the index of the language processing ability (or the degree of the burden on the user's body) of the user. Each time an update cycle of the index arrives, the wearable device 500 (e.g., the processor 310) may perform operation 910.

In the example shown in FIG. 10, when an update cycle of the index of the language processing ability (or the degree of the burden on the user's body) of the user arrives, the processor 310 may calculate the index to be 0.2. The processor 310 may determine that the calculated index (e.g., 0.2) is less than the first range.

A speech order of the sentence group 1001 (or the order in which the sentence group 1001 is used for voice generation of the wearable device 500) may arrive. The processor 310 may identify the sentence type (e.g., E type) of the sentence group 1001 and may select the first number (e.g., one) of sentences from the sentences in the sentence group 1001 of the E type according to a determined rule (e.g., Table 5 above). The processor 310 may generate a voice based on the selected sentence from the sentence group 1001 and may provide the voice to the user.

A speech order of the sentence group 1002 (or the order in which the sentence group 1002 is used for voice generation of the wearable device 500) may arrive. The processor 310 may identify the sentence type (e.g., C type) of the sentence group 1002 and may select the first number (e.g., one) of sentences from the sentences in the sentence group 1002 of the C type according to the determined rule (e.g., Table 5 above). The processor 310 may generate a voice based on the selected sentence from the sentence group 1002 and may provide the voice to the user.

A speech order of the sentence group 1003 (or the order in which the sentence group 1003 is used for voice generation of the wearable device 500) may arrive. The processor 310 may identify the sentence type (e.g., I type) of the sentence group 1003 and may select the first number (e.g., one) of sentences from the sentences in the sentence group 1003 of the I type according to the determined rule (e.g., Table 5 above). The processor 310 may generate a voice based on the selected sentence from the sentence group 1003 and may provide the voice to the user.

A speech order of the sentence group 1004 (or the order in which the sentence group 1004 is used for voice generation of the wearable device 500) may arrive. The processor 310 may identify the sentence type (e.g., N type) of the sentence group 1004 and may select the second number (e.g., two) of sentences from the sentences in the sentence group 1004 of the N type according to the determined rule (e.g., Table 5 above). The processor 310 may generate a voice based on the selected sentence from the sentence group 1004 and may provide the voice to the user.

A speech order of the sentence group 1005 (or the order in which the sentence group 1005 is used for voice generation of the wearable device 500) may arrive. The processor 310 may identify the sentence type (e.g., C type) of the sentence group 1005 and may select the first number (e.g., one) of sentences from the sentences in the sentence group 1005 of the C type according to the determined rule (e.g., Table 5 above). The processor 310 may generate a voice based on the selected sentence from the sentence group 1005 and may provide the voice to the user.

The update cycle of the index may arrive, and the processor 310 may calculate the index of the language processing ability (or the degree of the burden on the user's body) of the user to be 0.8. The processor 310 may determine that the calculated index (e.g., 0.8) exceeds the first range.

After calculating the index (e.g., 0.8), a speech order of the sentence group 1006 (or the order in which the sentence group 1006 is used for voice generation of the wearable device 500) may arrive. The processor 310 may identify the sentence type (e.g., C type) of the sentence group 1006 and may select the second number (e.g., two) of sentences from the sentences in the sentence group 1006 of the C type according to the determined rule (e.g., Table 5 above). The processor 310 may generate a voice based on the selected sentence from the sentence group 1006 and may provide the voice to the user.

A speech order of the sentence group 1007 (or the order in which the sentence group 1007 is used for voice generation of the wearable device 500) may arrive. The processor 310 may identify the sentence type (e.g., C type) of the sentence group 1007 and may select the second number (e.g., two) of sentences from the sentences in the sentence group 1007 of the C type according to the determined rule (e.g., Table 5 above). The processor 310 may generate a voice based on the selected sentence from the sentence group 1007 and may provide the voice to the user.

A speech order of the sentence group 1008 (or the order in which the sentence group 1008 is used for voice generation of the wearable device 500) may arrive. The processor 310 may identify the sentence type (e.g., I type) of the sentence group 1008 and may select the third number (e.g., three) of sentences from the sentences in the sentence group 1008 of the I type according to the determined rule (e.g., Table 5 above). The processor 310 may generate a voice based on the selected sentence from the sentence group 1008 and may provide the voice to the user.

A speech order of the sentence group 1009 (or the order in which the sentence group 1009 is used for voice generation of the wearable device 500) may arrive. The processor 310 may identify the sentence type (e.g., I type) of the sentence group 1009 and may select the third number (e.g., three) of sentences from the sentences in the sentence group 1009 of the I type according to the determined rule (e.g., Table 5 above). The processor 310 may generate a voice based on the selected sentence from the sentence group 1009 and may provide the voice to the user.

A speech order of the sentence group 1010 (or the order in which the sentence group 1010 is used for voice generation of the wearable device 500) may arrive. The processor 310 may identify the sentence type (e.g., E type) of the sentence group 1010 and may select the third number (e.g., three) of sentences from the sentences in the sentence group 1010 of the E type according to a determined rule (e.g., Table 5 above). The processor 310 may generate a voice based on the selected sentence from the sentence group 1010 and may provide the voice to the user.

According to an embodiment, the operations of the wearable device 500 described with reference to FIGS. 9 and 10 may be performed by the electronic device 510. For example, the electronic device 510 may perform operations 910 and 920 described with reference to FIG. 9. The electronic device 510 may calculate the index of the language processing ability of the user and may select a sentence based on the calculated index. The electronic device 510 may generate a voice based on the selected sentence and may provide the voice to the user.

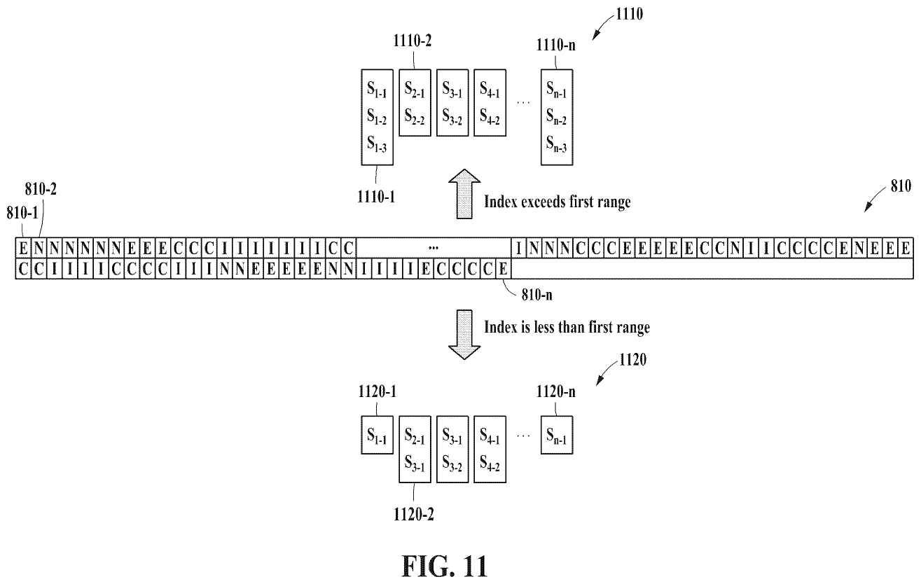

FIGS. 11, 12, and 13 are diagrams illustrating examples of speech styles of a wearable device according to an example embodiment(s).

According to an embodiment, a speech style of the wearable device 500 may indicate, for example, how frequently the wearable device 500 speaks and how long a single speech lasts. The speech style of the wearable device 500 may indicate the speech frequency (or the number of speeches) of the wearable device 500 and the speech length of a single speech. The speech frequency (or the number of speeches) of the wearable device 500 may be related to the number of sentence groups. The speech length of the single speech may be related to the number of selected sentences from one sentence group.

According to an embodiment, the speech styles of the wearable device 500 may be classified based on the speech frequency and the speech length.

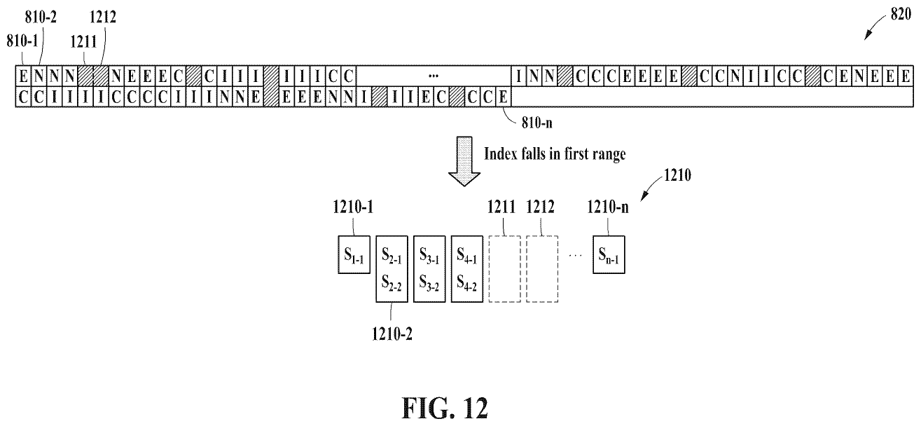

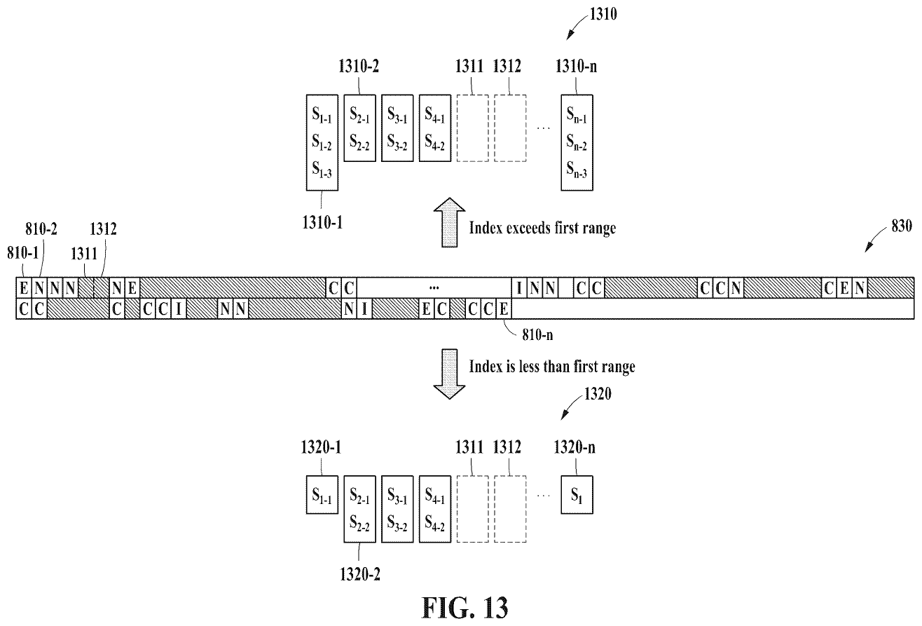

In FIG. 11, an example of a first speech style 1110 (e.g., a detailed style indicating a speech style in which the wearable device frequently speaks and the speech length of a single speech is long) of the wearable device 500 and an example of a second speech style 1120 (e.g., an attentive style indicating a speech style in which the wearable device 500 frequently speaks and the speech length of a single speech is short) are illustrated. In FIG. 12, an example of a third speech style 1210 (e.g., a standard style in which the number of speeches and the speech length of the wearable device 500 are moderate) of the wearable device 500 is illustrated, and in FIG. 13, an example of a fourth speech style 1310 (e.g., a cautious style indicating a speech style in which the number of speeches of the wearable device 500 is small and the speech length of a single speech is long) of the wearable device 500 and an example of a fifth speech style 1320 (e.g., a simplified style indicating a speech style in which the number of speeches of the wearable device 500 is small and the speech length of a single speech is short) are illustrated.

According to an embodiment, when the wearable device 500 selects all sentence groups of the sentence set 810 and the index of the language processing ability of the user exceeds the first range, the speech style of the wearable device 500 may correspond to, for example, the first speech style 1110 of FIG. 11. A sentence group 1110-1 of the first speech style 1110 may correspond to a group in which the sentences S1-1, S1-2, and S1-3 of the sentence group 810-1 are selected. A sentence group 1110-2 of the first speech style 1110 may correspond to a group in which the sentences S2-1 and S2-2 of the sentence group 810-2 are selected. A sentence group 1110-n of the first speech style 1110 may correspond to a group in which the sentences Sn-1, Sn-2, and Sn-3 of the sentence group 810-n are selected.

According to an embodiment, when the wearable device 500 selects all sentence groups of the sentence set 810 and the index of the language processing ability of the user is less than the first range, the speech style of the wearable device 500 may correspond to, for example, the second speech style 1120 of FIG. 11. A sentence group 1120-1 of the second speech style 1120 may correspond to a group in which a sentence S1-1 of the sentence group 810-1 is selected. A sentence group 1120-2 of the second speech style 1120 may correspond to a group in which the sentences S2-2 and S2-2 of the sentence group 810-2 are selected. A sentence group 1120-n of the second speech style 1120 may correspond to a group in which the sentence Sn-1 of the sentence group 810-n is selected.

According to an embodiment, when the wearable device 500 selects the first sentence groups 820 from the sentence set 810 and the index of the language processing ability of the user falls in the first range, the speech style of the wearable device 500 may correspond to, for example, the third speech style 1210 of FIG. 12. A sentence group 1210-1 of the third speech style 1210 may correspond to a group in which the sentence S1-1 of the sentence group 810-1 is selected. A sentence group 1210-2 of the third speech style 1210 may correspond to a group in which the sentences S2-3 and S2-2 of the sentence group 810-2 are selected. A sentence group 1210-n of the third speech style 1210 may correspond to a group in which the sentence Sn-1 of the sentence group 810-n is selected. A sentence group 1211 and a sentence group 1212 may correspond to unselected sentence groups (or omitted sentence groups).

According to an embodiment, when the wearable device 500 selects the second sentence groups 830 from the sentence set 810 and the index of the language processing ability of the user exceeds the first range, the speech style of the wearable device 500 may correspond to, for example, the fourth speech style 1310 of FIG. 13. A sentence group 1310-1 of the fourth speech style 1310 may correspond to a group in which the sentences S1-1, S1-2, and S1-3 of the sentence group 810-1 are selected. A sentence group 1310-2 of the fourth speech style 1310 may correspond to a group in which the sentences S2-4 and S2-2 of the sentence group 810-2 are selected. A sentence group 1310-n of the fourth speech style 1310 may correspond to a group in which the sentences Sn-1, Sn-2, and Sn-3 of the sentence group 810-n are selected. In the fourth speech style 1310, sentence groups 1311 and 1312 may indicate unselected sentence groups (or omitted sentence groups).

According to an embodiment, when the wearable device 500 selects the second sentence groups 830 from the sentence set 810 and the index of the language processing ability of the user is less than the first range, the speech style of the wearable device 500 may correspond to, for example, the fifth speech style 1320 of FIG. 13. A sentence group 1320-1 of the fifth speech style 1320 may correspond to a group in which the sentence S1-1 of the sentence group 810-1 is selected. A sentence group 1320-2 of the fifth speech style 1320 may correspond to a group in which the sentences S2-1 and S2-2 of the sentence group 810-2 are selected. A sentence group 1320-n of the fifth speech style 1320 may correspond to a group in which the sentence Sn-1 of the sentence group 810-n is selected. In the fifth speech style 1320, the sentence groups 1311 and 1312 may indicate unselected sentence groups (or omitted sentence groups).

According to an embodiment, the speech style of the wearable device 500 may change while the user performs an exercise. For example, before the user starts exercising, the wearable device 500 may select the second sentence groups 830 from the sentence set 810 and may calculate the index to be 0.2 as shown in the example of FIG. 10. In this case, the speech style of the wearable device 500 may correspond to the fourth speech style 1310. When the update cycle of the index arrives, the wearable device 500 may calculate the index to be 0.8 as shown in the example of FIG. 10. In this case, the speech style of the wearable device 500 may correspond to the fifth speech style 1320.

According to an embodiment, the wearable device 500 may determine the speech style of the wearable device 500 based on the number of times that the user performs the exercise according to an exercise program (or the number of times that the user uses the exercise program) (hereinafter, also referred to as a “count of exercise executions”).

For example, the wearable device 500 may check the count of exercise executions of the user. When the count of exercise executions of the user is less than a first count (e.g., three), the wearable device 500 may determine the speech style of the wearable device 500 to be the first speech style 1110. When the count of exercise executions of the user is less than the first count, the user may not be familiar with the exercise according to the exercise program and the voice of the wearable device 500. When the count of exercise executions of the user is less than the first count (e.g., 10), the wearable device 500 may determine the speech style of the wearable device 500 to be the first speech style 1110 to ensure that the speech amount of the wearable device 500 is relatively large. The wearable device 500 may determine the speech style to be the first speech style 1110 to frequently speak and provide a detailed description of the exercise to the user. The wearable device 500 may generate a voice based on the first speech style 1110 and may provide the voice to the user.

When the count of exercise executions of the user is greater than or equal to the first count (e.g., three) and less than a second count (e.g., 10), the wearable device 500 may determine the speech style of the wearable device 500 to be the second speech style 1120. The user may be relatively more familiar with the exercise according to the exercise program and the voice of the wearable device 500 when the count of exercise executions of the user is greater than or equal to the first count and less than the second count compared to when the count of exercise executions of the user is less than the first count. When the count of exercise executions of the user is greater than or equal to the first count and less than the second count, the wearable device 500 may determine the speech style of the wearable device 500 to be the second speech style 1120 to decrease the speech amount of the wearable device 500. The wearable device 500 may generate a voice based on the second speech style 1120 and may provide the voice to the user. The speech amount of the wearable device 500 may decrease in the second speech style 1120 compared to the first speech style 1110.

When the count of exercise executions of the user is greater than or equal to the second count (e.g., 10) and less than a third count (e.g., 20), the wearable device 500 may determine the speech style of the wearable device 500 to be the third speech style 1210. The user may be relatively more familiar with the exercise according to the exercise program and the voice of the wearable device 500 when the count of exercise executions of the user is greater than or equal to the second count and less than the third count compared to when the count of exercise executions of the user is greater than or equal to the first count and less than the first count. When the count of exercise executions of the user is greater than or equal to the second count and less than the third count, the wearable device 500 may determine the speech style of the wearable device 500 to be the third speech style 1210 to ensure that the speech amount of the wearable device 500 is moderate. The wearable device 500 may generate a voice based on the third speech style 1210 and may provide the voice to the user. The speech amount of the wearable device 500 may decrease in the third speech style 1210 compared to the second speech style 1120.

When the count of exercise executions of the user is greater than or equal to the third count (e.g., 20) and less than a fourth count (e.g., 30), the wearable device 500 may determine the speech style of the wearable device 500 to be the fourth speech style 1310. The user may be relatively more familiar with the exercise according to the exercise program and the voice of the wearable device 500 when the count of exercise executions of the user is greater than or equal to the third count and less than the fourth count compared to when the count of exercise executions of the user is greater than or equal to the second count and less than the third count. When the count of exercise executions of the user is greater than or equal to the third count and less than the fourth count, the wearable device 500 may determine the speech style of the wearable device 500 to be the fourth speech style 1310 to decrease the speech amount of the wearable device 500. The wearable device 500 may generate a voice based on the fourth speech style 1310 and may provide the voice to the user. The speech amount of the wearable device 500 may decrease in the fourth speech style 1310 compared to the third speech style 1210.

When the count of exercise executions of the user is greater than or equal to the fourth count (e.g., 30), the wearable device 500 may determine the speech style of the wearable device 500 to be the fifth speech style 1320. The user may be relatively more familiar with the exercise according to the exercise program and the voice of the wearable device 500 when the count of exercise executions of the user is greater than or equal to the fourth count compared to when the count of exercise executions of the user is greater than or equal to the third count and less than the fourth count. When the count of exercise executions of the user is greater than or equal to the fourth count, the wearable device 500 may determine the speech style of the wearable device 500 to be the fifth speech style 1320 to decrease the speech amount of the wearable device 500. The wearable device 500 may generate a voice based on the fifth speech style 1320 and may provide the voice to the user. The speech amount of the wearable device 500 may decrease in the fifth speech style 1320 compared to the fourth speech style 1310.

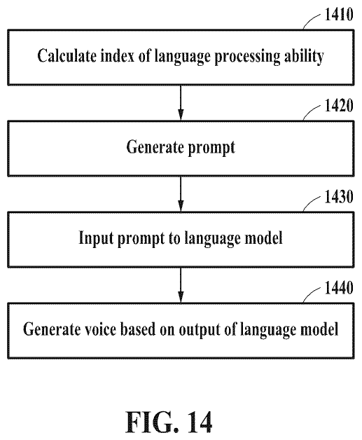

FIG. 14 is a diagram illustrating an example of a method of generating a sentence by a wearable device by using a language model according to an example embodiment.

Referring to FIG. 14, in operation 1410, the wearable device 500 (e.g., the processor 310) may calculate an index of a language processing ability (or a degree of the burden on the user's body). The description of operation 910 may apply to the description of operation 1410.

In operation 1420, the wearable device 500 (e.g., the processor 310) may generate a prompt based on the calculated index. For example, the processor 310 may generate a first prompt (e.g., According to the measurement result, your step length is short. If your step length is short, your walking posture may be unbalanced, and it is difficult to obtain the effect of the muscle strengthening exercise through walking. To increase the step length, straighten your knees first, step forward powerfully with your legs, and try walking by landing on your heels and then powerfully pushing off with your big toes) based on the calculated index. In another example, the processor 310 may generate a second prompt (e.g., If your step length is short, your walking posture may be unbalanced, and it is difficult to obtain the effect of the muscle strengthening exercise through walking) based on the calculated index.

In operation 1430, the wearable device 500 (e.g., the processor 310) may input the prompt to a language model (e.g., a large language model (LLM) or a small language model (SLM)). The language model may be stored in, for example, the memory 350. The wearable device 500 (e.g., the processor 310) may input information about whether to reduce (or increase) the number of sentences together with the prompt to the language model. For example, the processor 310 may input the first prompt and information instructing to reduce the number of sentences to a first level (e.g., shorten/level 1) to the language model. In another example, the processor 310 may input the first prompt and information instructing to reduce the number of sentences to a second level (e.g., shorten/level 2) to the language model. In another example, the processor 310 may input the second prompt and information instructing to increase the number of sentences to a maximum level (e.g., lengthen/level max) to the language model.

In operation 1440, the wearable device 500 (e.g., the processor 310) may generate a voice based on the output of the language model. For example, when the processor 310 inputs the first prompt and the information indicating to reduce the number of sentences to the first level to the language model, the processor 310 may obtain a first output (e.g., Your step length is short. Since the short step length causes an unbalanced walking posture and reduces the effect of the muscle strengthening exercise, it is important to straighten your knees and walk using the entire soles of your feet to increase the step length) from the language model and may generate a voice based on the first output. In another example, when the processor 310 inputs the first prompt and the information indicating to reduce the number of sentences to the second level to the language model, the processor 310 may obtain a second output (e.g., The short step length causes an unbalanced walking posture and reduces the effect of muscle strengthening, so straighten your knees and walk with your entire soles) from the language model.

The wearable device 500 (e.g., the processor 310) may provide the generated voice to the user. The wearable device 500 (e.g., the processor 310) may provide a customized voice to the user by performing operations 1410 to 1440.

Depending on the embodiments, the language model may be in a server, and when the wearable device 500 generates a prompt, the wearable device 500 may transmit the prompt and the information about whether to reduce (or increase) the number of sentences to the server. The server may input the prompt and the information about whether to reduce (or increase) the number of sentences to the language model and may obtain an output from the language model. The server may transmit the output of the language model to the wearable device 500. The wearable device 500 may generate a voice based on the output received from the server and may provide the voice to the user.

According to an embodiment, a computing device may train an artificial intelligence (AI) model based on training data including biometric information (e.g., the heart rate or the respiratory rate). The AI model may determine the number of sentences according to the heart rate and/or the respiratory rate by training. The trained AI model may be stored in the memory 350 of the wearable device 500. The wearable device 500 may generate a sentence by using the trained AI model and the biometric information of the user, may generate a voice based on the generated sentence, and may provide the voice to the user.

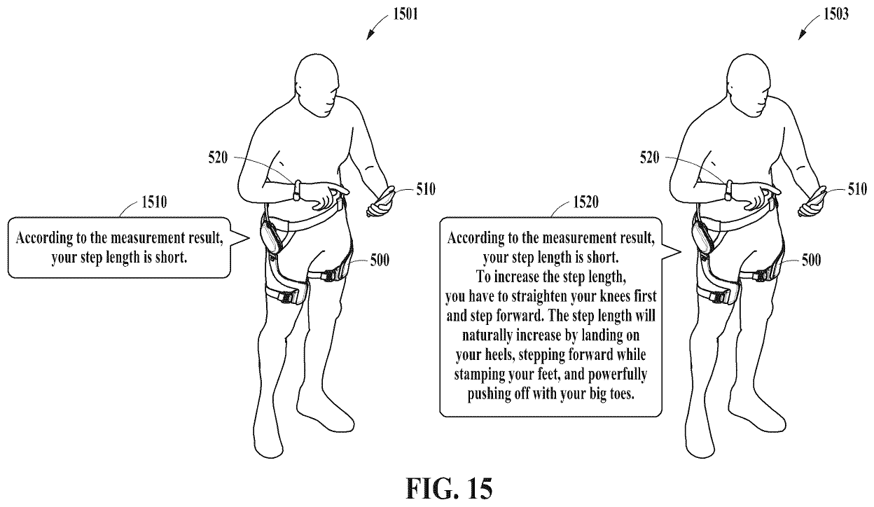

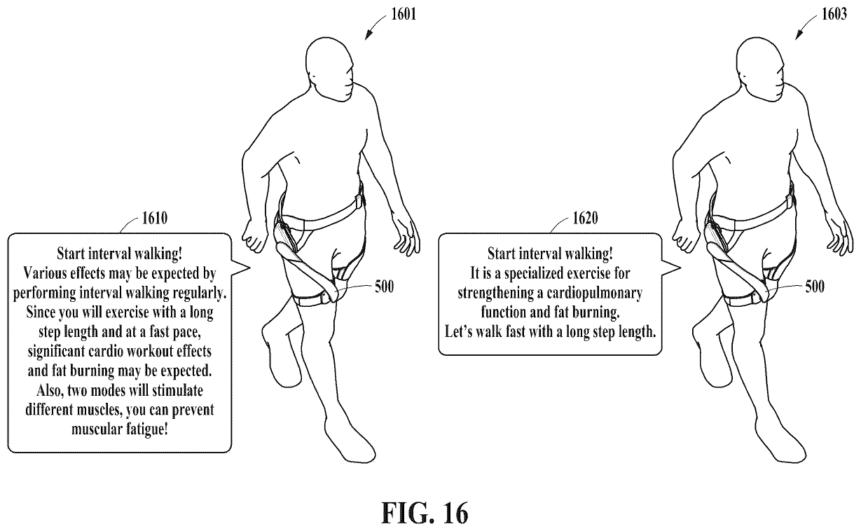

FIGS. 15 and 16 are diagrams illustrating examples of a speech operation of a wearable device according to an example embodiment(s).

Referring to FIG. 15, a first situation 1501 and a second situation 1503 are illustrated. The first situation 1501 may be a situation in which the wearable device 500 does not perform the adjustment of the speech amount described above, and the second situation 1503 may be a situation in which the wearable device 500 performs the adjustment of the speech amount described above.

In the first situation 1501 and the second situation 1503, the user may wear the wearable device 500 and the smartwatch 520 and may carry the electronic device 510. In the first situation 1501 and the second situation 1503, the heart rate of the user may be low (e.g., the heart rate of the user may be within a range of 50% to 60% of the maximum heart rate of the user), the respiration of the user may be within a normal range (e.g., 12 to 20 per minute), the settings information of the wearable device 500 may be “assistance mode/intensity level=1”, the moving speed of the user may be 0 km/h, and an environment in which the exercise of the user is performed may be indoors.

In the first situation 1501 and the second situation 1503, the language processing ability of the user may be high (or the degree of the burden on the user's body is low). When the wearable device 500 does not adjust the speech amount, a sentence 1510 with a small speech amount may be provided to the user through a voice such as the first situation 1501. In this case, the user may feel that the coaching of the wearable device 500 is insufficient, and the wearable device 500 may provide a voice (or voice feedback) that is inappropriate for a condition of the user. When the wearable device 500 adjusts the speech amount, a sentence 1520 with a large speech amount may be provided to the user through a voice such as the second situation 1503. In the second situation 1503, the speech style of the wearable device 500 may be, for example, the first speech style 1110 (e.g., a detailed style). In the second situation 1503, the wearable device 500 may provide, to the user, an optimized voice (or voice feedback) that suits the condition of the user, compared to the first situation 1501.

Referring to FIG. 16, a third situation 1601 and a fourth situation 1603 are illustrated. The third situation 1601 may be a situation in which the wearable device 500 does not perform the adjustment of the speech amount described above, and the fourth situation 1603 may be a situation in which the wearable device 500 performs the adjustment of the speech amount described above.

In the third situation 1601 and the fourth situation 1603, the user may wear the wearable device 500. In the third situation 1601 and the fourth situation 1603, the heart rate of the user may be high (e.g., the heart rate of the user may be within a range of 70% to 80% of the maximum heart rate of the user), the respiration of the user may exceed the normal range, the settings information of the wearable device 500 may be “resistance mode/intensity level=5”, the moving speed of the user may be 8 km/h, and the environment in which the exercise of the user is performed may be outdoors.

In the third situation 1601 and the fourth situation 1603, the language processing ability of the user may be low (or the degree of the burden on the user's body is high). When the wearable device 500 does not adjust the speech amount, a sentence 1610 with a large speech amount may be provided to the user through a voice such as the third situation 1601. Since the language processing ability of the user is low, the user may not be able to understand the sentence 1610 (or the voice of the wearable device 500) well. When the wearable device 500 adjusts the speech amount, a sentence 1620 with a small speech amount may be provided to the user through a voice such as the fourth situation 1603. In the fourth situation 1603, the speech style of the wearable device 500 may be, for example, the fifth speech style 1320 (e.g., a simplified style). In the fourth situation 1603, the wearable device 500 may provide, to the user, an optimized voice (or voice feedback) that suits the condition of the user, compared to the third situation 1601.

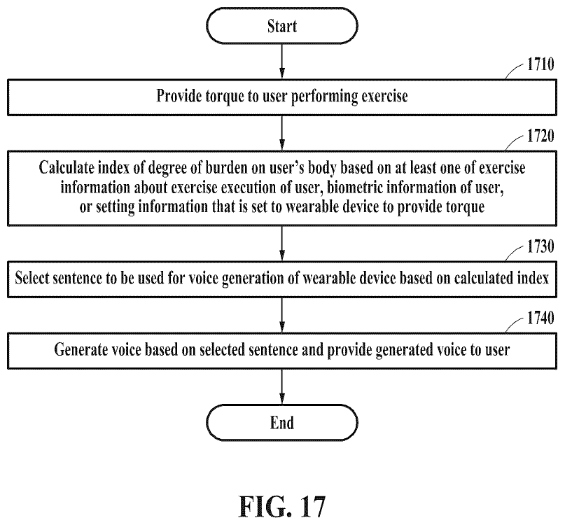

FIG. 17 is a flowchart illustrating an example of an operating method of a wearable device according to an example embodiment.

Referring to FIG. 17, in operation 1710, the wearable device 500 may provide a torque to a user performing an exercise. For example, the processor 310 of the wearable device 500 may control the driving module 30 to provide the torque to the user performing the exercise.

In operation 1720, the wearable device 500 may calculate an index of a degree of burden on the user's body (or the language processing ability of the user) based on at least one of exercise information about exercise execution of the user, biometric information of the user, or the settings information that is set to the wearable device 500 to provide a torque. The exercise information may include, for example, at least one of the moving speed (e.g., the walking speed) of the user, an exercise time, a change in an exercise posture, or a change in a coaching compliance rate. The biometric information may include, for example, at least one of heart rate information (or an increment of the heart rate) of the user or respiratory rate information (or an increment of the respiratory rate per minute) of the user. The settings information may include, for example, at least one of information about an operation mode (e.g., the assistance mode or the resistance mode) of the wearable device 500 or an intensity level related to the magnitude of the torque.

For example, the processor 310 may calculate the index based on the moving speed of the user, the information about the operation mode of the wearable device 500, the intensity level related to the magnitude of the torque of the wearable device 500, and at least one of the increment of the heart rate of the user and the increment of the respiratory rate per minute of the user.

In another example, the processor 310 may calculate the index based on the moving speed of the user, the information about the operation mode of the wearable device 500, and the intensity level related to the magnitude of the torque of the wearable device 500.

In another example, the processor 310 may calculate the index based on the change in the exercise posture of the user or the change in the coaching compliance rate of the user.

In operation 1730, the wearable device 500 may select a sentence (e.g., at least one of sentences of a target sentence group) to be used for voice generation of the wearable device 500 based on the calculated index. The target sentence group may indicate, for example, a sentence group of which a speech order (or a speech turn) has arrived after calculating the index among sentence groups (e.g., the sentence groups of the sentence set 810, the first sentence groups 820, or the second sentence groups 830).

According to an embodiment, the processor 310 may determine whether the calculated index falls within a first range (e.g., 0.3 to 0.7). When the processor 310 determines that the calculated index exceeds the first range, the processor 310 may select a first number (e.g., one) of sentences from the sentences of the sentence group (e.g., the target sentence group). When the processor 310 determines that the calculated index falls in the first range, the processor 310 may select a second number (e.g., two) of sentences from the sentences of the sentence group (e.g., the target sentence group). When the processor 310 determines that the calculated index is less than the first range, the processor 310 may select a third number (e.g., three) of sentences from the sentences of the sentence group (e.g., the target sentence group).

According to an embodiment, the processor 310 may determine whether the calculated index falls in the first range and may identify a sentence type of the sentence group (e.g., the target sentence group). When the calculated index falls in the first range and the sentence type is a first sentence type (e.g., the C type) to coach the exercise of the user or a second sentence type (e.g., the E type) for at least one of greeting, encouragement, or praise for the user, the processor 310 may select a first number of sentences from the sentences of the sentence group (e.g., the target sentence group). When the calculated index falls in the first range and the sentence type is a third sentence type (e.g., the I type) to deliver at least one of a result of the exercise of the user or exercise knowledge, the processor 310 may select a second number of sentences from the sentences of the sentence group (e.g., the target sentence group). When the calculated index exceeds the first range and the sentence type is the second sentence type or the third sentence type, the processor 310 may select a third number of sentences from the sentences of the sentence group (e.g., the target sentence group). When the calculated index exceeds the first range and the sentence type is the first sentence type, the processor 310 may select the second number of sentences from the sentences of the sentence group (e.g., the target sentence group).

In operation 1740, the wearable device 500 may generate a voice based on the selected sentence and may provide the generated voice to the user. For example, the processor 310 may convert the selected sentence into a voice and may control a speaker so that the voice is provided to the user through the speaker.

According to an embodiment, the wearable device 500 may determine whether the voice provided to the user is appropriate. For example, when the wearable device 500 receives, from the user who is exercising, an input to minimize voice provision and/or a volume level of the speaker of the wearable device 500 is adjusted (e.g., increase or decrease) by a determined percentage (e.g., 30%), the wearable device 500 may determine that the voice provided to the user is inappropriate. When the wearable device 500 determines that the voice provided to the user is inappropriate, the wearable device 500 may perform operation 1720. When the wearable device 500 determines that the voice provided to the user is inappropriate, even when an update cycle of the index has not arrived, the wearable device 500 may calculate the index of the degree of the burden on the user's body (or the language processing ability of the user) and may perform operations 1730 and 1740 after calculating the index.

According to an embodiment, when an exercise program for exercise is selected, the processor 310 may obtain a plurality of sentence groups (e.g., the sentence groups of the sentence set 810 of FIG. 8). The processor 310 may select some of the sentence groups based on at least one of the profile information of the user, information about whether there is an electronic device that establishes a wireless communication link with the wearable device 500, or the surrounding environmental information of the user. The profile information may include, for example, the age of the user, and the surrounding environmental information may include information about whether the environment in which the exercise of the user is performed is indoors or outdoors.

For example, when the age of the user is below a determined level, when there is an electronic device that establishes the wireless communication link with the wearable device 500, or when the environment in which the exercise of the user is performed is outdoors, the processor 310 may select first sentence groups (e.g., the first sentence groups 820 of FIG. 8) from the sentence groups (e.g., the sentence groups of the sentence set 810 of FIG. 8). When the age of the user is the determined level or above or there is no electronic device that establishes the wireless communication link with the wearable device 500, the processor 310 may select second sentence groups (e.g., the second sentence groups 830 of FIG. 8) from the sentence groups (e.g., the sentence groups of the sentence set 810 of FIG. 8).

According to an embodiment, the sentence groups (e.g., the sentence groups of the sentence set 810 of FIG. 8) may be classified based on sentence types (e.g., the N type, the I type, the C type, and the E type).

According to an embodiment, when the first sentence groups 820 are selected from the sentence groups (e.g., the sentence groups of the sentence set 810 of FIG. 8), rates at which respective sentence groups of at least some of the sentence types (e.g., the I type, the C type, and the E type) are selected from the sentence types may be the same. For example, referring to Table 2 above, in the second selection state, the selection rate (e.g., 66.6%) of the sentence groups of the I type, the selection rate (e.g., 66.6%) of the sentence groups of the C type, and the selection rate (e.g., 66.6%) of the sentence groups of the E type may be the same.

According to an embodiment, when the second sentence groups 830 are selected from the sentence groups (e.g., the sentence groups of the sentence set 810 of FIG. 8), rates at which respective sentence groups of the sentence types (e.g., the N type, the I type, the C type, and the E type) may be different from each other. For example, referring to Table 2 above, in the third selection state, the selection rate (e.g., 100%) of the sentence groups of the N type, the selection rate (e.g., 13.3%) of the sentence groups of the I type, the selection rate (e.g., 66.6%) of the sentence groups of the C type, and the selection rate (e.g., 6.66%) of the sentence groups of the E type may be different from each other.

The embodiments described with reference to FIGS. 1 to 16 may apply to the operating method of the wearable device 500 of FIG. 17.

According to an embodiment, the wearable device 120, 200, 300, 300-1, or 500 may include the driving module 30, the at least one processor 310 comprising processing circuitry, and memory 350 storing instructions. The instructions that, when executed by the at least one processor individually or collectively, may cause the wearable device to control the driving module to provide a torque to a user performing an exercise. The instructions that, when executed by the at least one processor individually or collectively, may cause the wearable device to obtain (or calculate) an index of burden on a body of the user based on at least one of exercise information about exercise execution of the user, biometric information of the user, or settings information that is set to the wearable device to provide the torque. The instructions that, when executed by the at least one processor individually or collectively, may cause the wearable device to select a sentence used for voice generation of the wearable device based on the index. The instructions that, when executed by the at least one processor individually or collectively, may cause the wearable device to generate a voice based on the selected sentence and provide the generated voice to the user.

The instructions that, when executed by the at least one processor individually or collectively, may cause the wearable device to determine whether the index falls within a first range. The instructions that, when executed by the at least one processor individually or collectively, may cause the wearable device to, based on a determination that the index exceeds the first range, select a first number of sentences from sentences of a sentence group of the wearable device. The instructions that, when executed by the at least one processor individually or collectively, may cause the wearable device to, based on a determination that the index falls within the first range, select a second number of sentences from the sentences of the sentence group.

The instructions that, when executed by the at least one processor individually or collectively, may cause the wearable device to, based on a determination that the index is less than the first range, select a third number of sentences from the sentences of the sentence group.

The instructions that, when executed by the at least one processor individually or collectively, may cause the wearable device to determine whether the index falls within a first range. The instructions that, when executed by the at least one processor individually or collectively, may cause the wearable device to identify a sentence type of a sentence group of the wearable device. The instructions that, when executed by the at least one processor individually or collectively, may cause the wearable device to when the index falls within the first range and the sentence type is a first sentence type to coach the exercise of the user or a second type for greeting, encouragement, or praise for the user, select the first number of sentences from sentences of the sentence group. The instructions that, when executed by the at least one processor individually or collectively, may cause the wearable device to when the index falls within the first range and the sentence type is a third sentence type for providing a result of the exercise of the user or exercise knowledge, select the second number of sentences from the sentences of the sentence group.

The instructions that, when executed by the at least one processor individually or collectively, may cause the wearable device to, based on a determination that the index exceeds the first range and the sentence type is the second sentence type or the third sentence type, select the third number of sentences from the sentences of the sentence group. The instructions that, when executed by the at least one processor individually or collectively, may cause the wearable device to, based on a determination that the index exceeds the first range and the sentence type is the first sentence type, select the second number of sentences from the sentences of the sentence group.

The instructions that, when executed by the at least one processor individually or collectively, may cause the wearable device to, when an exercise program for the exercise is selected, obtain a plurality of sentence groups. The instructions that, when executed by the at least one processor individually or collectively, may cause the wearable device to select some of the sentence groups based on at least one of profile information of the user, information about whether an electronic device that establishes a wireless communication link with the wearable device exists, or surrounding environmental information of the user.

The profile information may include an age of the user, and the surrounding environmental information may include information about whether an environment in which the exercise is performed is indoors or outdoors.

The instructions that, when executed by the at least one processor individually or collectively, may cause the wearable device to, when the age is below a determined level, when the electronic device exists, and/or the environment in which the exercise is performed is outdoors, select first sentence groups from the sentence groups. The instructions that, when executed by the at least one processor individually or collectively, may cause the wearable device to, when the age is the determined level or above and/or when the electronic device does not exist, select second sentence groups from the sentence groups. The number of first sentence groups may be greater than the number of second sentence groups.

The sentence groups may be classified based on sentence types.

When the first sentence groups are selected from the sentence groups, selection rates of respective sentence groups of at least some of the sentence types may be the same. When the second sentence groups are selected from the sentence groups, selection rates of respective sentence groups of the sentence types may be different.

The exercise information may include at least one of a moving speed of the user, an exercise time, a change in an exercise posture, or a change in a coaching compliance rate. The biometric information may include at least one of an increment of a heart rate of the user or an increment of a respiratory rate per minute. The settings information may include at least one of information about an operation mode of the wearable device or an intensity level related to a magnitude of the torque.

The instructions that, when executed by the at least one processor individually or collectively, may cause the wearable device to calculate the index based on the moving speed, the information about the operation mode, the intensity level related to the magnitude of the torque, and at least one of the increment of the heart rate and the increment of the respiratory rate per minute.

The instructions that, when executed by the at least one processor individually or collectively, may cause the wearable device to calculate the index based on the moving speed, the information about the operation mode, and the intensity level.

The instructions that, when executed by the at least one processor individually or collectively, may cause the wearable device to calculate the index based on the change in the exercise posture or the change in the coaching compliance rate.

According to an embodiment, the wearable device 120, 200, 300, 300-1, 500 may include the driving module 30, the processor 310 comprising processing circuitry, and memory 350 storing instructions. The instructions that, when executed by the at least one processor individually or collectively, may cause the wearable device to, when an exercise program is selected, obtain a plurality of sentence groups for the exercise program. The instructions that, when executed by the at least one processor individually or collectively, may cause the wearable device to determine sentence groups to be used for a voice service of the wearable device from the obtained sentence groups based on at least one of profile information of a user, information about whether an electronic device that establishes a wireless communication link with the wearable device exists, or surrounding environmental information of the user. The instructions that, when executed by the at least one processor individually or collectively, may cause the wearable device to control the driving module to provide a torque to the user performing an exercise of the exercise program.

The profile information may include an age of the user, and the surrounding environmental information may include information about whether an environment in which an exercise of the user is performed is indoors or outdoors.

The instructions that, when executed by the at least one processor individually or collectively, may cause the wearable device to, based on a determination that the age is below a determined level, the electronic device exists, and/or the environment in which the exercise is performed is outdoors, select first sentence groups from the obtained sentence groups. The instructions that, when executed by the at least one processor individually or collectively, may cause the wearable device to, based on a determination that the age is the determined level or above and/or the electronic device does not exist, select second sentence groups from the obtained sentence groups. The number of first sentence groups may be greater than the number of second sentence groups.

The obtained sentence groups may be classified into sentence types.

When the first sentence groups are selected from the obtained sentence groups, selection rates of respective sentence groups of at least some of the sentence types may be the same. When the second sentence groups are selected from the obtained sentence groups, selection rates of respective sentence groups of the sentence types may be different.

The instructions that, when executed by the at least one processor individually or collectively, may cause the wearable device to obtain (or calculate) an index of a degree of burden on a body of the user based on at least one of exercise information about exercise execution of the user, biometric information of the user, or settings information that is set to the wearable device to provide the torque. The instructions that, when executed by the at least one processor individually or collectively, may cause the wearable device to select at least one sentence from sentences of a target sentence group of which a speech order arrives among the determined sentence groups, based on the index.

The instructions that, when executed by the at least one processor individually or collectively, may cause the wearable device to determine whether the index falls within a first range. The instructions that, when executed by the at least one processor individually or collectively, may cause the wearable device to, based on a determination that the index exceeds the first range, select a first number of sentences from the sentences. The instructions that, when executed by the at least one processor individually or collectively, may cause the wearable device to, based on a determination that the index falls within the first range, select a second number of sentences from the sentences. The instructions that, when executed by the at least one processor individually or collectively, may cause the wearable device to, based on a determination that the index is less than the first range, select a third number of sentences from the sentences.

The exercise information may include at least one of a moving speed of the user, an exercise time, a change in an exercise posture, or a change in a coaching compliance rate. The biometric information may include at least one of an increment of a heart rate of the user or an increment of a respiratory rate per minute. The settings information may include at least one of information about an operation mode of the wearable device or an intensity level related to a magnitude of the torque.

The instructions that, when executed by the at least one processor individually or collectively, may cause the wearable device to calculate the index based on the moving speed, the information about the operation mode, the intensity level related to the magnitude of the torque, and at least one of the increment of the heart rate and the increment of the respiratory rate per minute.

According to an embodiment, a method of operating the wearable device 120, 200, 300, 300-1, 500 may include (i) providing a torque to a user who performs an exercise, (ii) obtaining (or calculating) an index of a degree of burden on a body of the user based on at least one of exercise information about exercise execution of the user, biometric information of the user, or settings information that is set to the wearable device to provide the torque, (iii) selecting a sentence used for voice generation of the wearable device based on the index, and (iv) generating a voice based on the selected sentence and providing the generated voice to the user.

According to an embodiment, a method of operating the wearable device 120, 200, 300, 300-1, 500 may include (i) obtaining a plurality of sentences groups when an exercise program is selected, (ii) determining sentence groups to be used for a voice service of the wearable device based on at least one of profile information of a user, information about whether an electronic device that establishes a wireless communication link with the wearable device exists, or surrounding environmental information of the user.

The embodiments described herein may be implemented using a hardware component, a software component and/or a combination thereof. A processing device may be implemented using one or more general-purpose or special-purpose computers, such as, for example, a processor, a controller and an arithmetic logic unit (ALU), a digital signal processor (DSP), a microcomputer, an FPGA, a programmable logic unit (PLU), a microprocessor, or any other device capable of responding to and executing instructions in a defined manner.

The processing device may run an operating system (OS) and one or more software applications that run on the OS. The processing device also may access, store, manipulate, process, and create data in response to execution of the software. For purpose of simplicity, the description of a processing device is used as singular; however, one skilled in the art will appreciate that a processing device may include multiple processing elements and multiple types of processing elements (e.g., a “processor” may include one or more processors, each comprising processing circuitry). For example, the processing device, or a “processor,” may include a plurality of processors, or a single processor and a single controller. In addition, different processing configurations are possible, such as parallel processors.

Thus, each “processor” herein includes processing circuitry, and/or may include multiple processors. For example, as used herein, including the claims, the term “processor” may include various processing circuitry, including at least one processor, wherein one or more of at least one processor, individually and/or collectively in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited/disclosed functions, e.g., in a distributed manner. At least one processor may execute program instructions to achieve or perform various functions.

Each embodiment herein may be used in combination with any other embodiment(s) described herein.

The software may include a computer program, a piece of code, an instruction, or some combination thereof, to independently or uniformly instruct or configure the processing device to operate as desired. Software and data may be stored in any type of machine, component, physical or virtual equipment, or computer storage medium or device capable of providing instructions or data to or being interpreted by the processing device. The software also may be distributed over network-coupled computer systems so that the software is stored and executed in a distributed fashion. The software and data may be stored by one or more non-transitory computer-readable recording mediums.

The methods according to the above-described embodiments may be recorded in non-transitory computer-readable media including program instructions to implement various operations of the above-described embodiments. The media may also include, alone or in combination with the program instructions, data files, data structures, and the like. The program instructions recorded on the media may be those specially designed and constructed for the purposes of example embodiments, or they may be of the kind well-known and available to those having skill in the computer software arts. Examples of non-transitory computer-readable media include magnetic media such as hard disks, floppy disks, and magnetic tape; optical media such as CD-ROM discs, DVDs, and/or Blue-ray discs; magneto-optical media such as optical discs; and hardware devices that are specially configured to store and perform program instructions, such as read-only memory (ROM), random access memory (RAM), flash memory (e.g., USB flash drives, memory cards, memory sticks, etc.), and the like. Examples of program instructions include both machine code, such as produced by a compiler, and files containing higher-level code that may be executed by the computer using an interpreter. The above-described hardware devices may be configured to act as one or more software modules in order to perform the operations of the above-described examples, or vice versa.

As described above, although the embodiments have been described with reference to the limited drawings, a person skilled in the art may apply various technical modifications and variations based thereon. For example, suitable results may be achieved if the described techniques are performed in a different order and/or if components in a described system . . . architecture, device, or circuit are combined in a different manner and/or replaced or supplemented by other components or their equivalents.

Accordingly, other implementations are within the scope of the following claims.

What is claimed is:

1. A wearable device comprising:
a driving module comprising a motor and/or circuitry;
at least one processor comprising processing circuitry; and
memory storing instructions that, when executed by the at least one processor individually or collectively, cause the wearable device to:
control the driving module to provide a torque to a user performing an exercise,
obtain an index of burden on a body of the user based on at least one of exercise information about exercise execution of the user, biometric information of the user, or settings information that is set to the wearable device to provide the torque,
select a sentence used for voice generation of the wearable device based on the index, and
generate a voice based on the selected sentence and provide the generated voice to the user.

2. The wearable device of claim 1, wherein the instructions that, when executed by the at least one processor individually or collectively, cause the wearable device to:
determine whether the index falls within a first range,
based on a determination that the index exceeds the first range, select a first number of sentences from sentences of a sentence group of the wearable device, and
based on a determination that the index falls within the first range, select a second number of sentences from the sentences of the sentence group.

3. The wearable device of claim 2, wherein the instructions that, when executed by the at least one processor individually or collectively, cause the wearable device to, based on a determination that the index is less than the first range, select a third number of sentences from the sentences of the sentence group.

4. The wearable device of claim 1, wherein the instructions that, when executed by the at least one processor individually or collectively, cause the wearable device to:
determine whether the index falls within a first range and identify a sentence type of a sentence group of the wearable device,
when the index falls within the first range and the sentence type is a first sentence type to coach the exercise of the user or a second type for greeting, encouragement, or praise for the user, select a first number of sentences from sentences of the sentence group, and
when the index falls within the first range and the sentence type is a third sentence type for providing a result of the exercise of the user or exercise knowledge, select a second number of sentences from the sentences of the sentence group.

5. The wearable device of claim 4, wherein the instructions that, when executed by the at least one processor individually or collectively, cause the wearable device to:
based on a determination that the index exceeds the first range and the sentence type is the second sentence type or the third sentence type, select a third number of sentences from the sentences of the sentence group, and
based on a determination that the index exceeds the first range and the sentence type is the first sentence type, select the second number of sentences from the sentences of the sentence group.

6. The wearable device of claim 1, wherein the instructions that, when executed by the at least one processor individually or collectively, cause the wearable device to:
when an exercise program for the exercise is selected, obtain a plurality of sentence groups, and
select some of the sentence groups based on at least one of profile information of the user, information about whether an electronic device that establishes a wireless communication link with the wearable device exists, or surrounding environmental information of the user.

7. The wearable device of claim 6, wherein the profile information includes an age of the user, and the surrounding environmental information includes information about whether an environment in which the exercise is performed is indoors or outdoors, and
the instructions that, when executed by the at least one processor individually or collectively, cause the wearable device to:
when the age is below a determined level, when the electronic device exists, and/or the environment in which the exercise is performed is outdoors, select first sentence groups from the sentence groups, and
when the age is the determined level or above and/or when the electronic device does not exist, select second sentence groups from the sentence groups,
wherein a number of first sentence groups is greater than a number of second sentence groups.

8. The wearable device of claim 7, wherein the sentence groups are classified based on sentence types,
when the first sentence groups are selected from the sentence groups, selection rates of respective sentence groups of at least some of the sentence types are the same, and
when the second sentence groups are selected from the sentence groups, selection rates of respective sentence groups of the sentence types are different.

9. The wearable device of claim 1, wherein the exercise information includes at least one of a moving speed of the user, an exercise time, a change in an exercise posture, or a change in a coaching compliance rate,
the biometric information includes at least one of an increment of a heart rate of the user or an increment of a respiratory rate per minute, and
the settings information includes at least one of information about an operation mode of the wearable device or an intensity level related to a magnitude of the torque.

10. The wearable device of claim 9, wherein the instructions that, when executed by the at least one processor individually or collectively, cause the wearable device to calculate the index based on the moving speed, the information about the operation mode, the intensity level related to the magnitude of the torque, and at least one of the increment of the heart rate and the increment of the respiratory rate per minute.

11. The wearable device of claim 9, wherein the instructions that, when executed by the at least one processor individually or collectively, cause the wearable device to calculate the index based on the moving speed, the information about the operation mode, and the intensity level.

12. The wearable device of claim 9, wherein the instructions that, when executed by the at least one processor individually or collectively, cause the wearable device to calculate the index based on the change in the exercise posture or the change in the coaching compliance rate.

13. A wearable device comprising:
a driving module comprising a motor and/or circuitry;
at least one processor comprising processing circuitry; and
memory storing instructions that, when executed by the at least one processor individually or collectively, cause the wearable device to:
when an exercise program is selected, obtain a plurality of sentence groups for the exercise program,
determine sentence groups to be used for a voice service of the wearable device from the obtained sentence groups based on at least one of profile information of a user, information about whether an electronic device that establishes a wireless communication link with the wearable device exists, or surrounding environmental information of the user, and
control the driving module to provide a torque to the user performing an exercise of the exercise program.

14. The wearable device of claim 13, wherein the profile information includes an age of the user, and the surrounding environmental information includes information about whether an environment in which an exercise of the user is performed is indoors or outdoors, and
the instructions that, when executed by the at least one processor individually or collectively, cause the wearable device to:
based on a determination that the age is below a determined level, the electronic device exists, and/or the environment in which the exercise of the user is performed is outdoors, select first sentence groups from the obtained sentence groups, and
based on a determination that the age is the determined level or above and/or the electronic device does not exist, select second sentence groups from the obtained sentence groups, and
wherein a number of first sentence groups is greater than a number of second sentence groups.

15. The wearable device of claim 14, wherein the obtained sentence groups are classified into sentence types,
when the first sentence groups are selected from the obtained sentence groups, selection rates of respective sentence groups of at least some of the sentence types are the same, and
when the second sentence groups are selected from the obtained sentence groups, selection rates of respective sentence groups of the sentence types are different.

16. The wearable device of claim 13, wherein the instructions that, when executed by the at least one processor individually or collectively, cause the wearable device to:
obtain an index of a degree of burden on a body of the user based on at least one of exercise information about exercise execution of the user, biometric information of the user, or settings information that is set to the wearable device to provide the torque, and
select at least one sentence from sentences of a target sentence group of which a speech order arrives among the determined sentence groups, based on the index.

17. The wearable device of claim 16, wherein the instructions that, when executed by the at least one processor individually or collectively, cause the wearable device to:
determine whether the index falls within a first range,
based on a determination that the index exceeds the first range, select a first number of sentences from the sentences,
based on a determination that the index falls within the first range, select a second number of sentences from the sentences, and
based on a determination that the index is less than the first range, select a third number of sentences from the sentences.

18. The wearable device of claim 16, wherein the exercise information includes at least one of a moving speed of the user, an exercise time, a change in an exercise posture, or a change in a coaching compliance rate,
the biometric information includes at least one of an increment of a heart rate of the user or an increment of a respiratory rate per minute, and
the settings information includes at least one of information about an operation mode of the wearable device or an intensity level related to a magnitude of the torque.

19. The wearable device of claim 18, wherein the instructions that, when executed by the at least one processor individually or collectively, cause the wearable device to calculate the index based on the moving speed, the information about the operation mode, the intensity level related to the magnitude of the torque, and at least one of the increment of the heart rate and the increment of the respiratory rate per minute.

20. A method of operating a wearable device, the method comprising:
providing a torque to a user who performs an exercise;
obtaining an index of a degree of burden on a body of the user based on at least one of exercise information about exercise execution of the user, biometric information of the user, or settings information that is set to the wearable device to provide the torque;
selecting a sentence used for voice generation of the wearable device based on the index; and
generating a voice based on the selected sentence and providing the generated voice to the user.
